(19) United States
(12) Patent Application Publication
(10) Pub. No.: US 2023/0120534 A1
(43) Pub. Date: Apr. 20, 2023

(54) Methods for Conditional Transaction Tokens, Secure Sharing of Token Assets, Wallet Spam Protection, and User Interfaces for Acceptance of Terms

(71) Applicant: Artema Labs, Inc, Los Angeles, CA (US)

(72) Inventors: Bjorn Markus Jakobsson, Portola Valley, CA (US); Stephen C. Gerber, Austin, TX (US); Keir Finlow-Bates, Eura (FI)

(73) Assignee: Artema Labs, Inc, Los Angeles, CA (US)

(21) Appl. No.: 17/823,014

(22) Filed: Aug. 29, 2022

Related U.S. Application Data
(60) Provisional application No. 63/362,586, filed on Apr. 6, 2022.
(60) Provisional application No. 63/282,072, filed on Nov. 22, 2021.
(60) Provisional application No. 63/270,386, filed on Oct. 21, 2021.
(60) Provisional application No. 63/238,180, filed on Aug. 29, 2021.

(51) Int. Cl. G06Q 20/38; H04L 9/32; G06F 21/10

(52) U.S. Cl. CPC G06Q 20/389; H04L 9/3213; G06F 21/10; G06F 2221/2141; G06F 2221/0788

(57) ABSTRACT

Devices can be configured to implement distributed ledgers capable of immutably recording a first set of data and a second set of data of an item, wherein the second set of data is made available by satisfaction of a condition. Such devices can include network interfaces, memory and processors. The processors can be configured to obtain a conditional item. The conditional item includes a first set of data that is available. The conditional item can further include a second set of data that is unavailable. The processor can be further configured to determine whether a condition is satisfied, and when the condition is satisfied perform an evolution to the conditional item.

### CROSS-REFERENCE TO RELATED APPLICATIONS

This application claims benefit of and priority under 35 U.S.C. 119(e) to U.S. Provisional Patent Application No. 63/238,180 entitled “Conditional Transaction Tokens” by Jakobsson, filed Aug. 29, 2021, U.S. Provisional Patent Application No. 63/270,386 entitled “Secure Sharing of Token Assets” by Jakobsson, filed Oct. 21, 2021, U.S. Provisional Patent Application No. 63/282,072 entitled “Wallet Spam Detection and Protection Method” by Jakobsson et al., filed Nov. 22, 2021, and U.S. Provisional Patent Application No. 63/362,586 entitled “User Interface for Conveyance of Terms” by Jakobsson et al., filed Apr. 6, 2022, the disclosures of which are hereby incorporated by reference in their entirety for all purposes.

### FIELD OF THE INVENTION

This invention relates to cryptography. More particularly it relates to immutable ledgers and verification mechanisms associated with cryptographic systems.

### BACKGROUND

Cryptography can be used to provide security, privacy and authenticity to transactions. Some cryptographic components, such as digital signatures and encryption functions, are standardized and well-studied with known security characteristics. Cryptography can be used to create immutable ledgers such as (but not limited to) blockchains. Immutable ledgers and blockchains can be based on a variety of cryptographic methods. In some implementations of immutable ledgers and blockchains, mining is used to securely add information. Mining can include computer systems (often referred to as “miners”) generating proofs based on computational challenges. Generally, a proof can be an output of a function that conforms to one or more requirements defined by a challenge. A proof protocol can be a function used to generate a proposed proof. The proof protocol can be iteratively performed until a proof is generated which meets the requirements of the challenge. The requirements of the challenge can be based on a difficulty. Mining can also include the use of computer systems known as “verifiers” that perform processes to check the generated proofs. In many instances, a proof can be easily verified based on providing successful inputs to a verifier. Miners and verifies can be implemented using any one or more of personal computers, application-specific integrated circuits, mobile devices (e.g., a mobile phone or tablet), server computer systems, virtual machines executing on computer systems, and/or any other form of computing device capable of performing computations associated with the performance of a particular mining or verifier function.

### SUMMARY OF THE INVENTION

A device can be configured to implement a distributed ledger capable of immutably recording a first set of data and a second set of data of an item, wherein the second set of data is made available by satisfaction of a condition. In an embodiment, the device includes a network interface, memory and a processor. The processor configured to obtain a conditional item. The conditional item includes a first set of data that is available. The first set of data includes first content, and a first policy. The conditional item further includes a second set of data that is unavailable. The second set of data includes second content, and a second policy. The processor further configured to determine whether a condition is satisfied, and when the condition is satisfied perform an evolution to the conditional item, wherein the evolution makes the second set of data become available, to generate a transaction record, the transaction record including the conditional item, and broadcast the transaction record. The transaction record configured to be incorporated into a ledger entry, wherein the ledger entry is capable of being used to compute a challenge for securely adding the ledger entry to a distributed ledger using a cryptographic system.

In another embodiment, the conditional item is a token.

In a further embodiment, the conditional item is a non-fungible token.

In yet another embodiment, the evolution alters access rights of the conditional item, wherein the access rights are associated with public keys.

In still another embodiment, the evolution alters ownership of the item.

In a yet further embodiment, the evolution alters the second content associated with the item.

In a still further embodiment, the evolution alters an image associated with the item.

In yet still another embodiment, the condition requires that a threshold number of blocks have been added to the distributed ledger since a transaction transferring ownership of the item has been recorded.

In a yet still further embodiment, the condition requires that a transaction recipient have specific characteristics.

In another further embodiment, the second set of data further includes personalizations, wherein the personalizations are determined based on qualifying transactions.

In yet another further embodiment, the second set of data can include personalizations, wherein the personalizations are determined based on qualifying transactions and personalizations effect a function of the conditional item.

In still another further embodiment, inspection of the first policy is available publicly using the distributed ledger.

In yet still another further embodiment, inspection of the first policy is available to particular entities based on public-key private-key encryption.

In yet still another further embodiment again, the condition can be satisfied based on an occurrence of an event.

In an additional embodiment, the condition can be satisfied based on an occurrence of an external event.

In another additional embodiment, the condition can be satisfied based on an occurrence of an internal event.

In yet another additional embodiment, the conditional item is associated with a related set of items, and the condition requires that the conditional item and at least one item from the related set of items are associated by ownership to a public key.

A device can be configured to implement a distributed ledger capable of immutably recording an action, the action selected based on an evaluation of an item policy. In an embodiment, the device includes a network interface, memory, and a processor. The processor configured to obtain a conditional item. The conditional item includes a set of data. The set of data includes content, a policy. The policy includes executable code. The processor further configured to execute the executable code to identify a request made to the conditional item, determine whether a condition has been satisfied, and select an action descriptor when the condition has been satisfied. The processor further configured to generate a transaction record, wherein the transaction record is generated based on the action descriptor, and broadcast the transaction record. The transaction record configured to be incorporated into a ledger entry, wherein the ledger entry is capable of being used to compute a challenge for securely adding the ledger entry to a distributed ledger using a cryptographic system.

In another embodiment, the transaction record includes address information for a content originator, wherein the content originator created the conditional item.

In a further embodiment, the transaction record is a wake-up signal.

In yet another embodiment, the conditional item is a token.

In still another embodiment, the conditional item is a non-fungible token.

In another further embodiment, the transaction record alters access rights of the conditional item, wherein the access rights are associated with public keys.

In a still further embodiment, the transaction record alters ownership of the conditional item.

In a yet further embodiment, the transaction record alters the content associated with the conditional item.

In another yet further embodiment, the transaction record alters an image associated with the conditional item.

In another still further embodiment, the condition requires that a threshold number of blocks have been added to the distributed ledger since a transaction transferring ownership of the conditional item has been recorded.

In another additional embodiment, the condition requires that a transaction recipient have specific characteristics.

In another additional further embodiment, the conditional item further includes personalizations, wherein the personalizations are determined based on a qualifying transaction.

In yet another additional further embodiment, the conditional item further includes personalizations, wherein the personalizations impact a function of the conditional item.

In another embodiment again, inspection of an initial policy associated with the conditional item is publicly available using the distributed ledger.

In still another embodiment again, inspection of an initial policy associated with the conditional item is available to particular entities based on public-key private-key encryption.

In yet still another embodiment again, the condition can be satisfied based on an occurrence of an event.

In yet still another additional embodiment again, the condition can be satisfied based on an occurrence of an external event.

In yet still another further embodiment again, the condition can be satisfied based on an occurrence of an internal event.

In yet still another further additional embodiment, the conditional item is associated with a related set of items, and the condition requires that the conditional item and at least one item from the related set of items are associated by ownership to a public key.

A device can be configured to implement a cryptographic wallet capable of initiating rendering of content by an output device. In an embodiment, the device includes a network interface, memory, and a processor. The processor configured to receive a service advertisement. The service advertisement associated with an output device. The processor further configured to access a ledger entry identifying one or more tokens associated with a public key, the one or more tokens associated with one or more content items. The processor further configured to determine, based on the service advertisement, whether the one or more content items can be rendered by the output device. The processor further configured to receive a selection identifying a selected content item from among the one or more content items, and to transmit storage entity instructions signed with a digital signature to a storage entity. The storage entity instructions include content item identification information associated with the selected content item, output device identification information associated with the output device, and a request for the storage entity to transmit the selected content item to the output device. The digital signature can be authenticated using the public key. The processor further configured to transmit output device instructions to initiate rendering of the selected content item.

In another embodiment, the service advertisement includes output device identification information associated with the output device.

In a further embodiment, the service advertisement includes output device rendering capabilities.

In still another embodiment, the ledger entry is stored on an immutable ledger.

In yet another embodiment, rendering includes at least one option selected from a group of displaying on a screen, sending to a speaker, processing on one or more processors.

In another further embodiment, the processor is further configured to display a visual indication based on the service advertisement.

In a still further embodiment, the processor is further configured to display a visual indication based on the service advertisement, the visual indication includes a description of a presence and capabilities of the output device.

In a yet further embodiment, the service advertisement includes rendering requirements of the output device.

In a still yet further embodiment, receiving a selection identifying a selected content item includes receiving an input from a user.

In another still further embodiment, the output device instructions can be executed conditional on one or more requirements.

In another yet further embodiment, the output device instructions can be executed conditional on one or more requirements determined by the processor.

In another still yet further embodiment, the output device instructions can be executed conditional on one or more requirements determined based on the selected content item.

In another further embodiment again, the storage entity instructions can be executed conditional on one or more requirements.

In another still further embodiment again, the storage entity instructions can be executed conditional on one or more requirements determined by the processor.

In another yet further embodiment again, the storage entity instructions can be executed conditional on one or more requirements determined based on the output device identification information.

In still yet another further embodiment again, the output device instructions are transmitted to the output device.

In another additional embodiment, the output device instructions are transmitted to the storage entity.

In another further additional embodiment, content items are associated with NFTs.

In yet another additional embodiment, the device and the output device communicate wirelessly.

In a still yet further additional embodiment, the device and the output device are separate devices.

An output device can be configured to render content received from a storage entity based on a request from a cryptographic wallet. In an embodiment, the output device includes an output system capable of rendering content, a network interface, memory and a processor. The processor configured to transmit a service advertisement. The service advertisement includes output device identification information, output device rendering capability information, a rendering requirement, and a public key. The processor further configured to receive a content item from a storage entity, receive rendering instructions, and determine that a rendering requirement has been met based on a ledger entry stored on an immutable ledger. The ledger entry includes a transaction record. The transaction record includes the public key. The processor further configured to render the content item based on the rendering instructions.

In another embodiment, the processor is further configured to determine whether a rendering requirement has been met based on the content item.

In a further embodiment, the processor is further configured to prepare logs includes usage data.

In yet another embodiment, the output system capable of rendering content includes at least one option selected from a group of terminals, TV screens, loudspeakers, headphones, actuators, engines, and heaters.

In a yet further embodiment, the rendering instructions can be executed conditional on one or more requirements.

In another further embodiment, the rendering instructions can be executed conditional on one or more requirements determined by the processor.

In yet another further embodiment, the rendering instructions can be executed conditional on one or more requirements, the one or more requirements included in the rendering instructions.

In yet another still further embodiment, the rendering instructions can be executed conditional on one or more requirements determined based on the content item.

In yet another still further embodiment again, the rendering instructions are received from at least one option selected from a group of a cryptographic wallet, and the storage entity.

A device can be configured to implement a storage entity capable of initiating rendering of content by an output device on behalf of a cryptographic wallet. In an embodiment, the device includes a network interface, memory and a processor. The processor configured to receive instructions signed with a digital signature. The instructions include content item identification information associated with a content item, output device identification information associated with an output device, a wallet public key associated with the content item, and an output device public key associated with the output device. The processor further configured to transmit the content item to the output device when the digital signature can be authenticated using the wallet public key, generate a transaction record that includes a transfer of tokens to the output device public key, and a reference to the content item, and broadcast the transaction record. The transaction record configured to be incorporated into a ledger entry, wherein the ledger entry is capable of being used to compute a challenge for securely adding the ledger entry to a distributed ledger using a cryptographic system.

In another embodiment, the instructions are received from a cryptographic wallet.

In a further embodiment, the processor is further configured to determine whether output device satisfies rendering requirements.

In another further embodiment, the processor is further configured to determine whether the output device satisfies rendering requirements, the rendering requirements associated with the content item.

A device can be configured to implement a distributed ledger capable of blocking transactions that lack access tokens. In an embodiment, the device includes a network interface, memory, and a processor. The processor configured to obtain a set of transaction records. Each transaction record includes a recipient public key, and an access token. The processor further configured to determine whether the access token is valid with respect to the recipient public key for each transaction record, and generate a ledger entry. The ledger entry includes each transaction record with a valid access token. The processor further configured to compute a challenge using a cryptographic system, wherein the challenge is based on the ledger entry, and broadcast a block that incorporates the ledger entry to securely add the block to a distributed ledger, wherein the block is capable of being validated by using a cryptographic system to obtain a proof based on the challenge.

In another embodiment, the processor is further configured to receive the block; and the proof is obtained based on the block.

In a further embodiment, the proof is generated based on an iterative process.

In yet another embodiment, the valid access token is further capable of being verified publicly.

In a yet further embodiment, valid access tokens are digital signatures capable of being verified using the recipient public key.

In another further embodiment, valid access tokens are digital signatures capable of being generated using a recipient private key, the recipient private key corresponding to the recipient public key.

In another yet further embodiment, the valid access token is capable of being verified based on a specified timeframe.

In another yet further embodiment again, the valid access token is capable of being verified based on a sender public key associated with each transaction record.

In still yet another further embodiment, the valid access token is capable of being verified based on a transaction identifier associated with each transaction record.

In still yet another further embodiment again, the valid access token is capable of being verified based on performing lookups to a database.

In another still yet further embodiment, the valid access token is capable of being verified based on performing lookups to a distributed ledger.

A device can be configured to implement a transaction reassigner capable of performing sorting actions for a wallet based on wallet permissions. The device includes a network interface, memory and a processor. the processor configured to obtain a transaction record. Wherein the transaction record includes a recipient public key, and an access token. The access token is capable of being verified based on the recipient public key. The processor is further configured to determine that the access token is not valid for the recipient public key, evaluate a smart contract and input to the smart contract a request including an action, the recipient public key, and a reassigner private key. The processor further configured to receive an approval from the smart contract, and perform an action on a wallet using the reassigner private key, the wallet associated with the recipient public key, wherein the action based is on the transaction record.

In another embodiment, a verifiability of the access token is based on a token type associated with the transaction record.

In a further embodiment, the access token is a digital signature.

In still another embodiment, the access token is capable of being verified based on a specified timeframe.

In another embodiment again, the access token is capable of being verified based on a sender public key associated with the transaction record.

In still another additional embodiment, the access token is capable of being verified based on a transaction identifier associated with the transaction record.

In still another additional embodiment again, the access token is capable of being verified based on performing lookups to a database.

In yet another embodiment, the access token is capable of being verified based on performing lookups to a distributed ledger.

In a still further embodiment, the smart contract can selectively enable the processor to perform actions.

In still further embodiment again, the smart contract can selectively enable the processor to perform actions based on the transaction record.

In a still yet further embodiment, the smart contract can selectively enable the processor to perform actions based on a policy, wherein the policy can include one or more rules selected from a group of the processor cannot block transfers out from the wallet of any token that corresponds to crypto funds, the processor cannot cause transfers out from the wallet of any token that corresponds to crypto funds, the processor can only perform actions within a specified time from a transaction record time, the processor can only perform actions on transaction records that do not include valid access tokens.

In another still yet further embodiment, the action can include placing the transaction record in a wallet partition associated with the wallet.

In a yet further embodiment, the action can include filtering actions.

In yet another still yet further embodiment, the action can be selected based on heuristic rules.

In still another embodiment, the action can be selected based on a whitelist.

In another additional embodiment again, the action can be selected based on a blocklist.

A device can be configured to implement a distributed ledger capable of immutably recording user interactions with content. The device includes a network interface, memory, and a processor. The processor configured to obtain a content item based on a metadata field, receive an indication of a user interaction, the user interaction associated with the content item and a recipient public key. The processor further configured to generate a transaction record when the indication meets a requirement. The transaction record includes a reference to a token. The token includes the metadata field, the recipient public key, and the indication of the user interaction. The processor further configured to broadcast the transaction record. The transaction record configured to be incorporated into a ledger entry. Wherein the ledger entry is capable of being used to compute a challenge for securely adding the ledger entry to an immutable ledger using a cryptographic system.

In another embodiment, the content item includes rules.

In a further embodiment, the indication of a user interaction with a content item includes a binary indication.

In a further additional embodiment, the content item includes a smart contract.

A device can be configured to implement a distributed ledger capable of immutably recording a first set of data and a second set of data of an item, wherein the second set of data is made available by satisfaction of a condition. In an embodiment, the device includes a network interface, memory, and a processor. The processor configured to obtain a conditional item at a transfer time. The conditional item includes a first set of data that is available. The first set of data includes first content, and a first policy. The first policy including first access rights. The first access rights associated with a content file and a public key. The first policy further including a condition, wherein the condition is satisfied after a preset amount of time elapses since the transfer time. The conditional item further including a second set of data that is unavailable. The second set of data includes second content, and a second policy including second access rights. The second access rights associated with the content file and the public key. The processor further configured to determine whether a condition is satisfied, and when the condition is satisfied perform an evolution to the conditional item. The evolution makes the second set of data become available.

In another embodiment, the conditional item is a token.

In a further embodiment, the conditional item is a non-fungible token.

In still another embodiment, the evolution alters an image associated with the item.

In a still further embodiment, the condition requires that a threshold number of blocks have been added to the distributed ledger since a transaction transferring ownership of the item has been recorded.

In still another embodiment, the condition requires that a transaction recipient have specific characteristics.

In yet another embodiment, the second set of data further includes personalizations, wherein the personalizations are determined based on qualifying transactions.

In another additional embodiment, the second set of data further includes personalizations, wherein the personalizations are determined based on qualifying transactions and personalizations affect a function of the conditional item.

In a further additional embodiment, inspection of the first policy is available publicly using the distributed ledger.

In a still yet further embodiment again, inspection of the first policy is available to particular entities based on public-key private-key encryption.

In still yet another embodiment, the condition can be satisfied based on an occurrence of an event.

In another additional embodiment again, the condition can be satisfied based on an occurrence of an external event.

In another still further embodiment again, the condition can be satisfied based on an occurrence of an internal event.

In another further additional embodiment, the conditional item is associated with a related set of items, and the condition requires that the conditional item and at least one item from the related set of items are associated by ownership to a public key.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 conceptually illustrates an example of a token including an embedded policy for controlling ownership and transfer rights.

FIG. 19 conceptually illustrates an example of a container (e.g., a token) for enabling original creators to receive tokens from a secondary transfer.

FIG. 20 conceptually illustrates an example process for unlocking token functionality based on a threshold duration.

FIG. 21 conceptually illustrates an example process for initiating a transaction in response to content being accessed.

FIG. 22 conceptually illustrates an example process for performing actions based on a wake-up signal.

FIG. 23 conceptually illustrates an example policy-based payment to a successful influencer.

FIG. 24 conceptually illustrates an example embodiment of a secure sharing architecture.

FIG. 25 conceptually illustrates an example process for displaying content in response to user inputs.

FIG. 26 conceptually illustrates an example user interface associated with a wallet.

FIG. 27 conceptually illustrates an example of a system for the review of a tentative transaction.

FIG. 28 conceptually illustrates an example of a system for the conveyance of transaction record classification.

FIG. 29a-b conceptually illustrates an example flowchart of a process for enabling the enforcement of rules associated with an NFT.

FIG. 30 conceptually illustrates an example implementation using a smart contract and a suitable blockchain wallet.

FIG. 31 conceptually illustrates an example of a device for enabling enforcing of rules associated with an NFT.

### DETAILED DESCRIPTION

Existing items, whether physical or virtual, do not enable conditional transaction control. An item can be resellable all the time, for example, as is traditional. Other items, such as a movie that a user buys or rents, cannot be transferred at all. Thus, the transfer policies are static. This limitation stymies the creation of beneficial applications. In several embodiments conditional transactions, conditional policy changes, and other conditional changes to items (e.g., tokens, NFTs, and other items) can be caused based on satisfied conditions.

In several embodiments, content can act at first as a rental (e.g., of a movie), that can be viewed only a limited number of times within a limited period of time after first being acquired, but which then (e.g., after a year), can allow any number of accesses by the one or more parties that performed the accesses in the first time period (e.g., as determined by the bonding of the movie at the time of the first viewing with a public key to which a user needs to prove knowledge of the corresponding secret key). Items with these characteristics are enabled by conditional policy (e.g., access policy) changes.

Wallets can be used to store crypto currencies and tokens, such as NFTs. However, it is sometimes assumed that the wallets and all associated devices needed to use wallet contents are trusted by wallet owners. This is an unreasonable assumption. When taking real-world settings into consideration, it is evident that wallet technology is lacking in terms of security and privacy, as well as flexibility to output content in a manner that is consistent with the security of output devices. In several embodiments, secure sharing architectures, processes, and devices are used to enable improved security and privacy for sharing content, and outputting content. In various embodiments, wallet information can be kept private from output devices. In many embodiments, output devices can advertise capabilities to applications on devices (e.g., mobile devices). In several embodiments, the improvements are applied to cryptographic systems, tokens, and/or NFTs. For example, in some embodiments, a user can store an NFT on a wallet, receive an advertisement of capabilities with a third-party owned output device, cause an output device to render (e.g., display) the content while maintaining privacy for the wallet, and/or send a transaction to the output device to facilitate the rendering of the content.

It is possible for users to create tokens, such as non-fungible tokens (NFTs) and gift them to other users without the consent of these other users. While this is not currently happening, that can simply be a matter of the costs associated with the minting of NFTs. Abuse in the form of unrequested and unwanted assignments of token ownership rights is likely to start happening (e.g., as a way of sending unsolicited commercial content). Today's wallets are not designed to address this threat, and the methods of blocking undesired ownership assignments, as well as undesired lending of tokens, cannot be addressed using existing anti-spam technologies, as these are inherently based on a centralized approach of communicating. In some embodiments, systems provide wallet spam detection and protection for distributed ledger systems.

Initial creators and/or sellers of tokens (e.g., non-fungible tokens (NFT)) often wish to place a recurring royalty obligation on future purchasers of the NFT (or tokens). In various embodiments, creators and/or sellers can place obligations on future holders transferors, and/or transferees. Obligations can be a recurring royalty obligation. A royalty obligation can include a process where the creator receives a percentage of the sales price every time their NFT is resold. In certain embodiments, initial creators/sellers can place usage restrictions on future purchasers of the NFT. In some embodiments, usage restrictions can allow an NFT holder to utilize an asset only for non-commercial, private purposes. In many embodiments, obligations and restrictions are implemented via an NFT's smart contract.

Problems can arise in that a royalty obligation or use restriction is a contractual obligation, and contractual obligations may not be binding on a downstream purchaser of the NFT unless the purchaser has been notified and agrees to pay the applicable royalty and abide by the usage terms. A purchaser of an NFT typically does not read the NFT's smart contract prior to purchase. At best the royalty obligation or usage restrictions are communicated to purchasers via the terms of service applicable to the marketplace where the original NFT was sold, but this becomes problematic if those terms of service change over time, if that marketplace ceases to operate, or if the NFT is resold on a different marketplace with different terms of service. There are currently no techniques embedded in the NFT itself to enforce notification and acceptance of such terms by downstream purchasers of NFTs. In various embodiments, acceptance of terms of service to perform actions with respect to an NFT can be required. The requirements can be required by the NFT. The actions can include NFT transfers, rendering of content, and other actions as described herein.

In traditional systems, a marketplace can present terms of service and policies to a user prior to a transaction or use, or the marketplace can choose not to. Similarly, whereas many traditional systems do enforce payment of royalties, that can easily be avoided by “discount” marketplaces, pirates and using private sales. As the market of cryptographic assets (e.g., tokens, NFTs) matures, such abuses can be likely to increase, and be used explicitly to circumvent requirements and reduce transaction costs. Similarly, some users can be tempted to use wallets that help them circumvent terms of service, e.g., related to enforcement of policies related to how to use content. In several embodiments, these problems are addressed by enabling the making of notifications and/or user agreement to terms a necessity for the performance of actions. In a number of embodiments, an action can be a sale, a use, and/or a content transformation. In many embodiments, these problems are addressed by enabling the running of scripts associated with or performing actions required by the terms, policies and/or royalty requirements. In various embodiments, scripts can be included in, referenced by, and/or activated by data included in metadata fields. Metadata fields can be associated to NFTs. A person of skill in the art will recognize that these two approaches can be combined, as can variations of these, of which there can be many.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

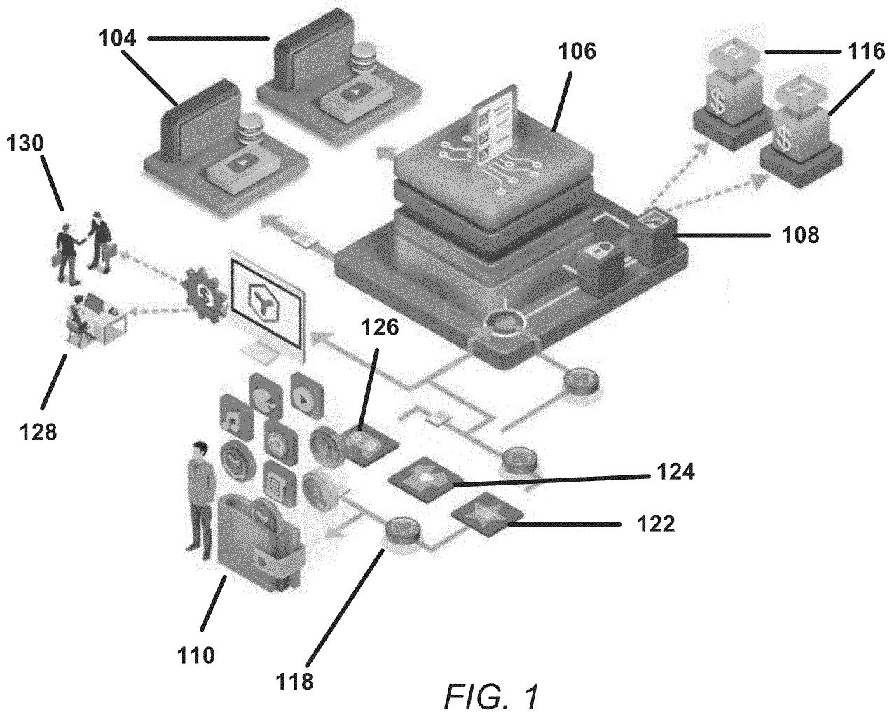

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

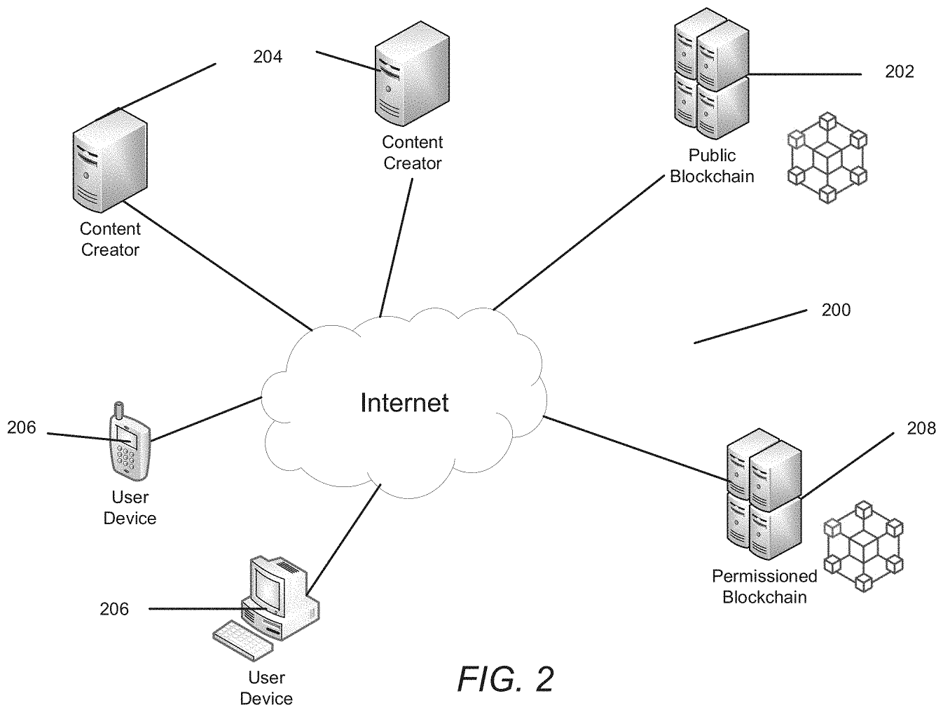

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

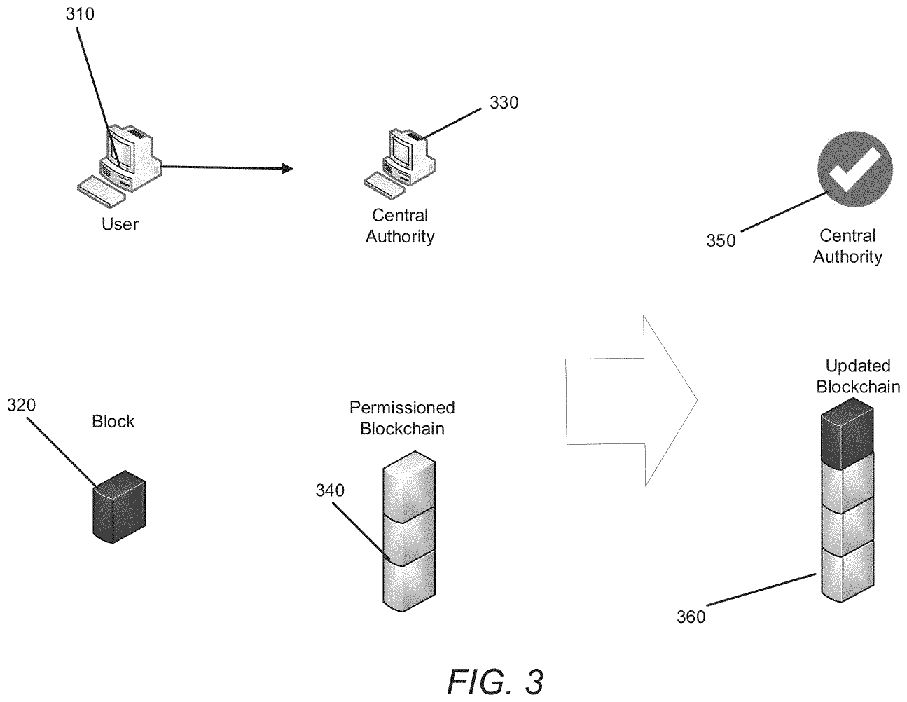

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

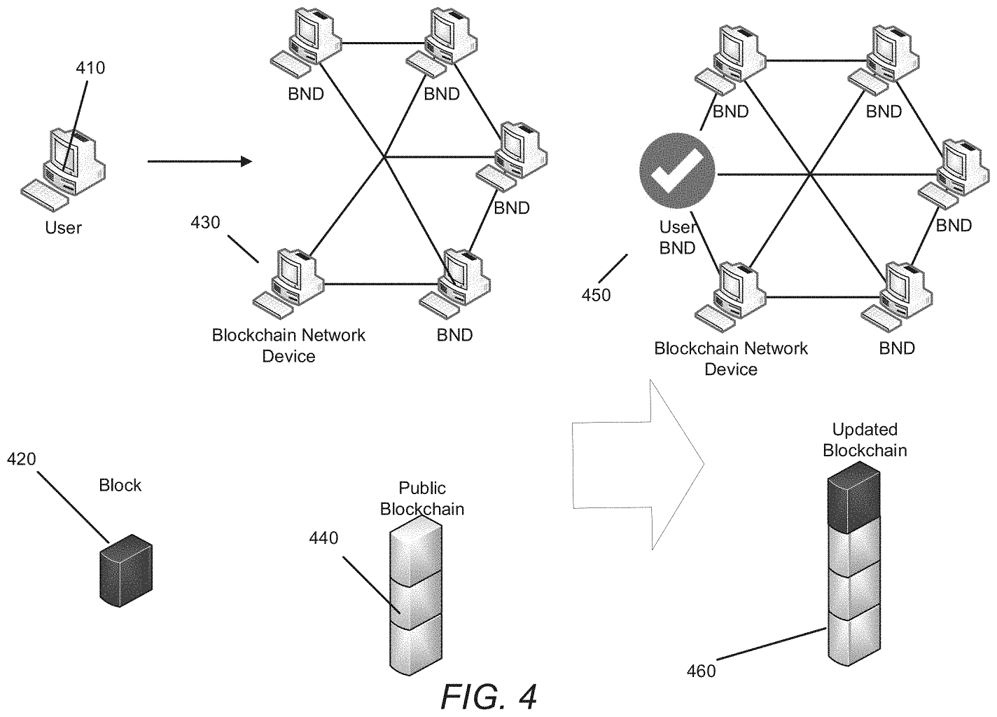

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

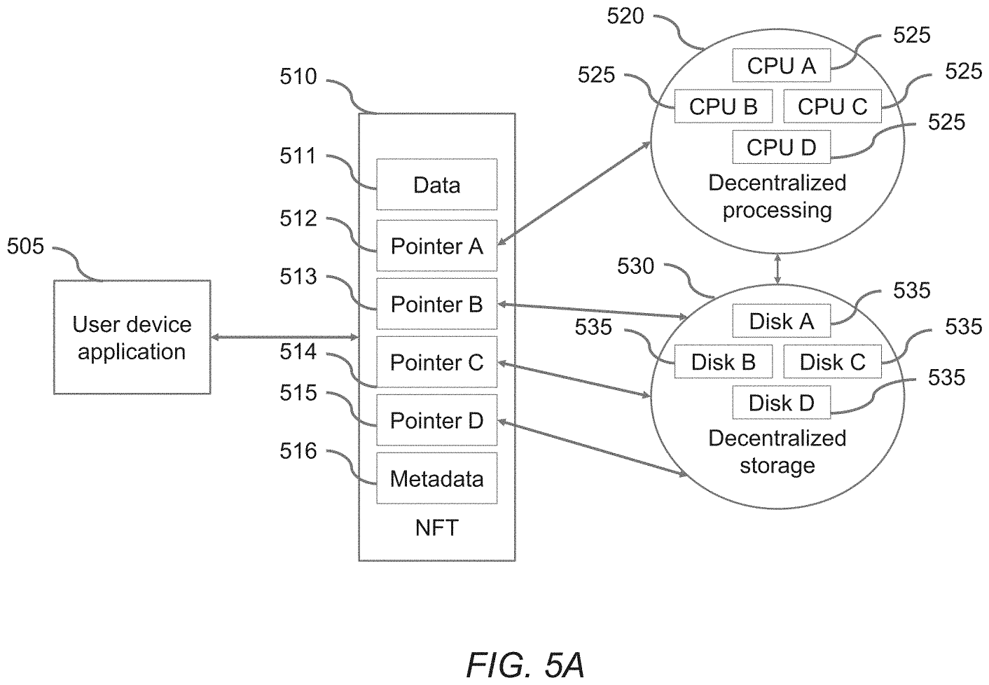

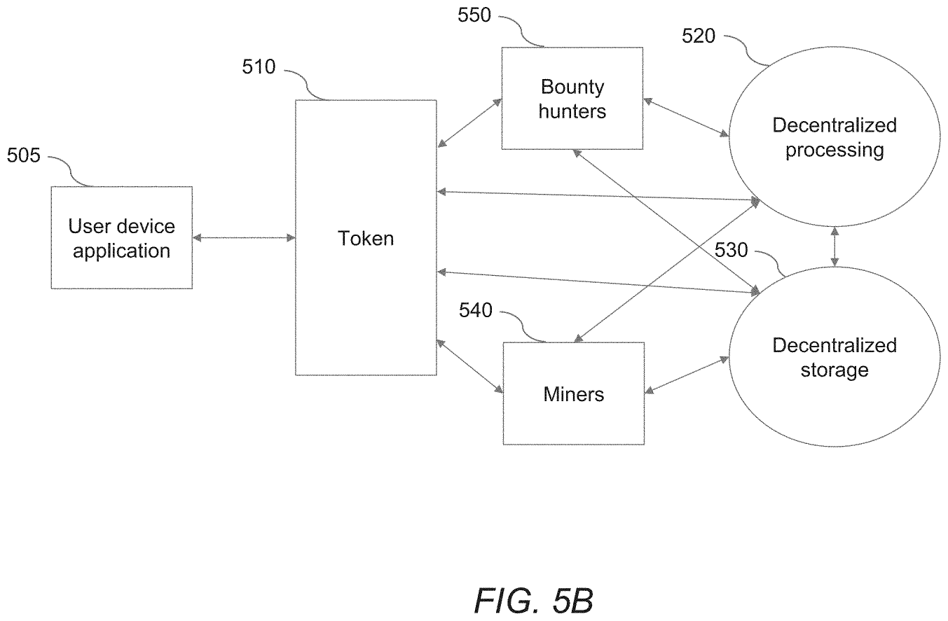

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

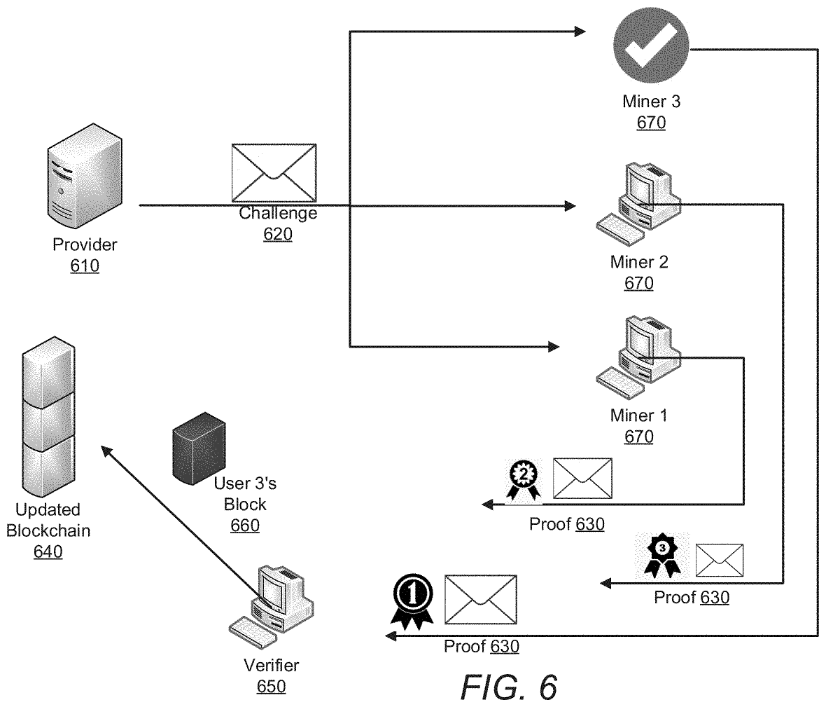

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

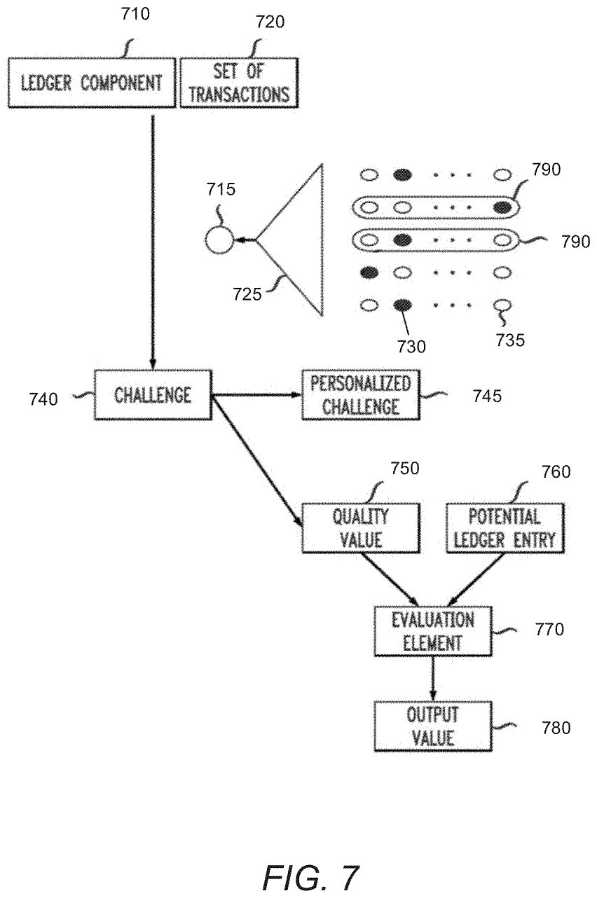

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory at the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

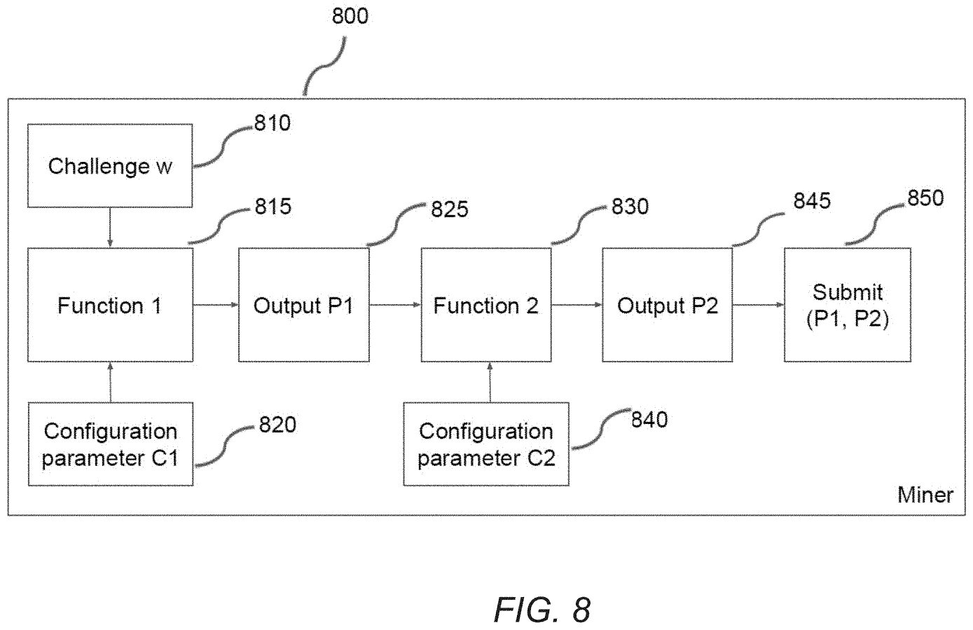

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

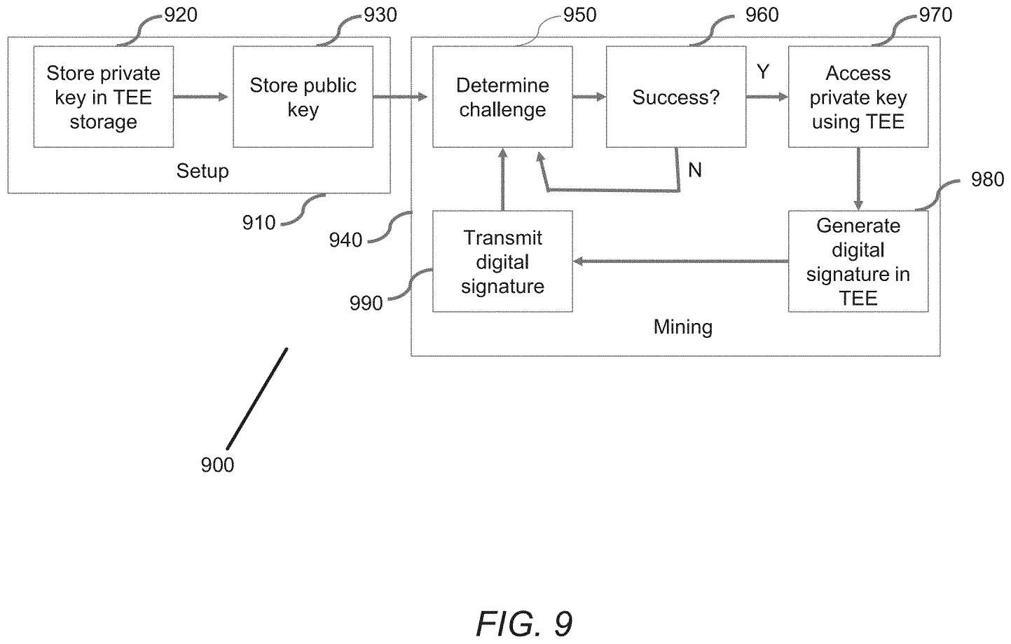

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

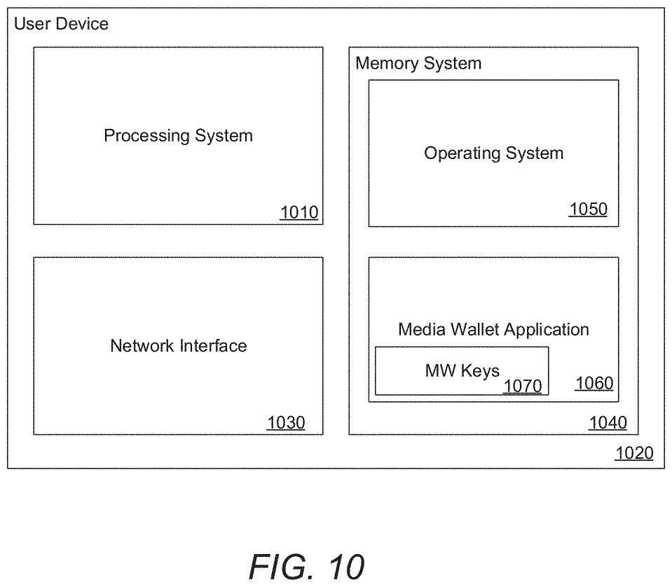

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

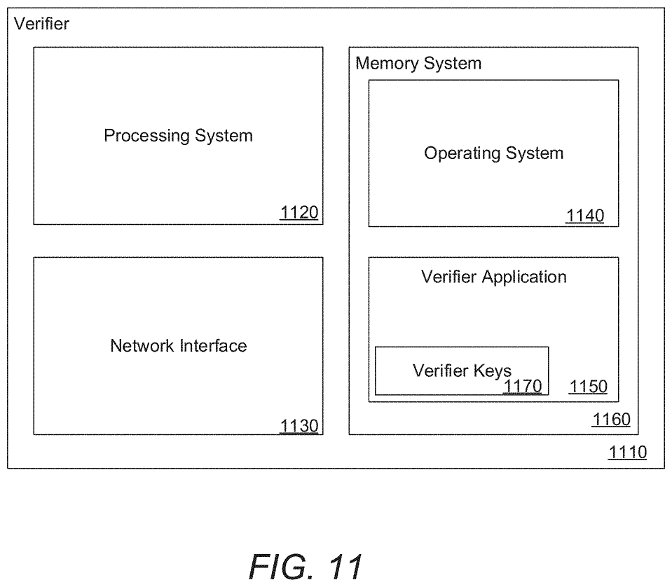

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

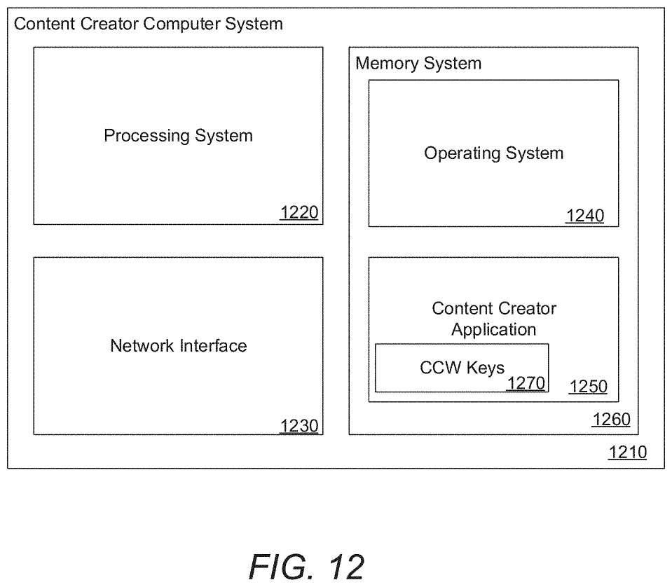

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

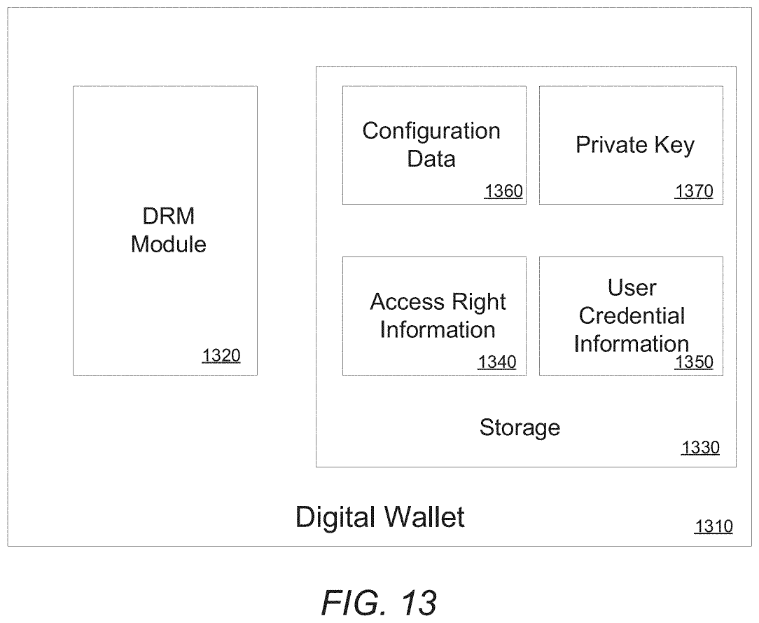

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

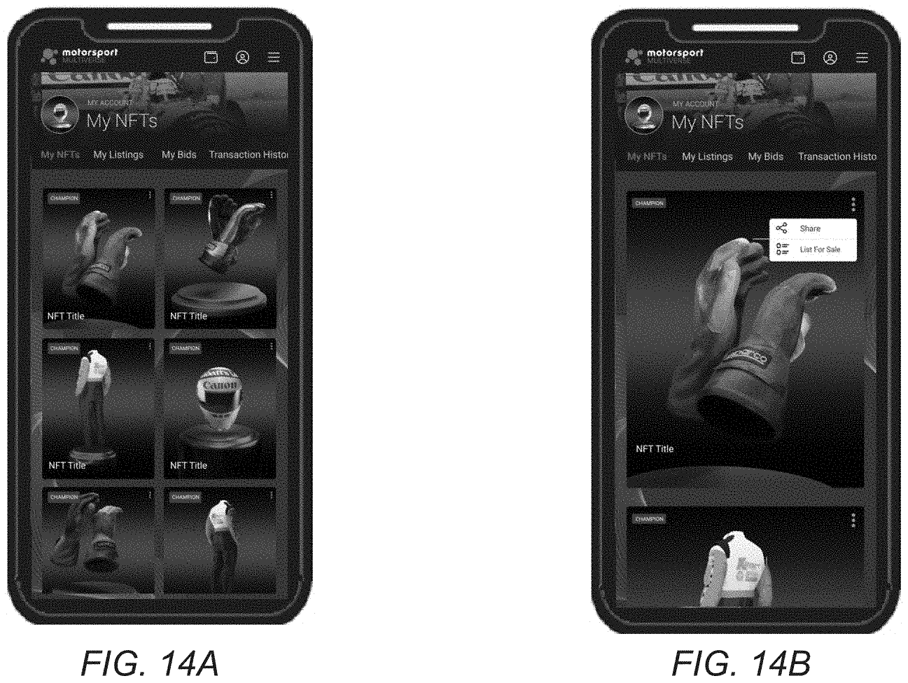

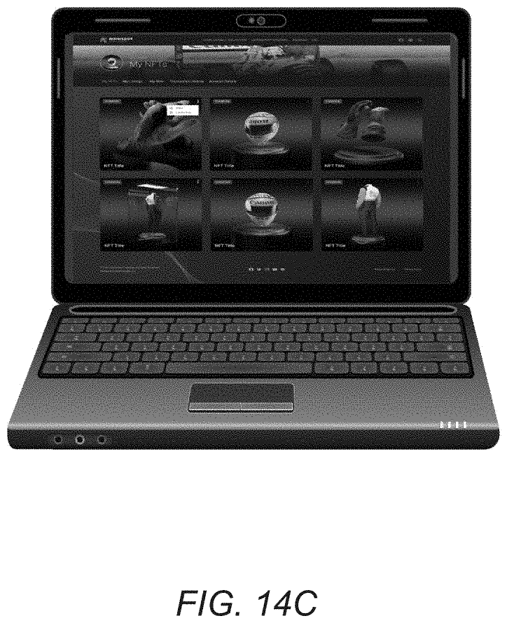

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

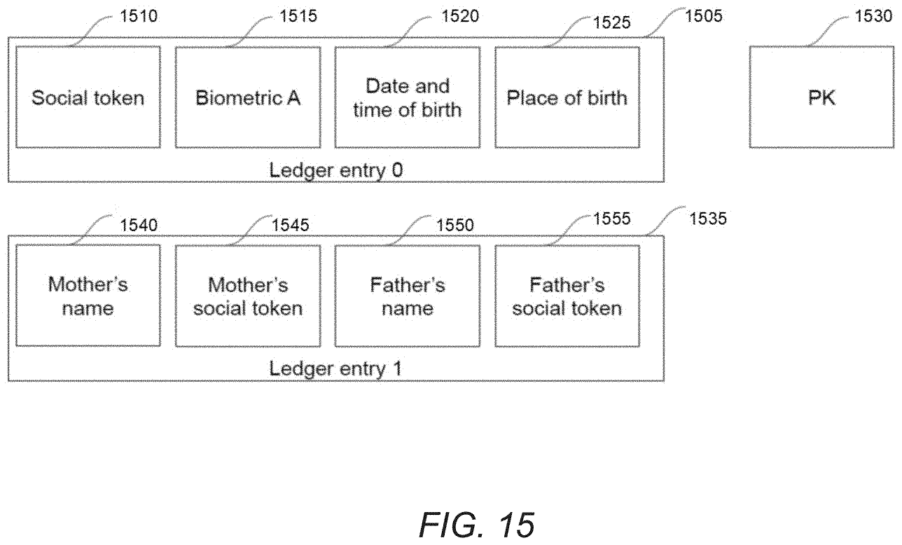

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

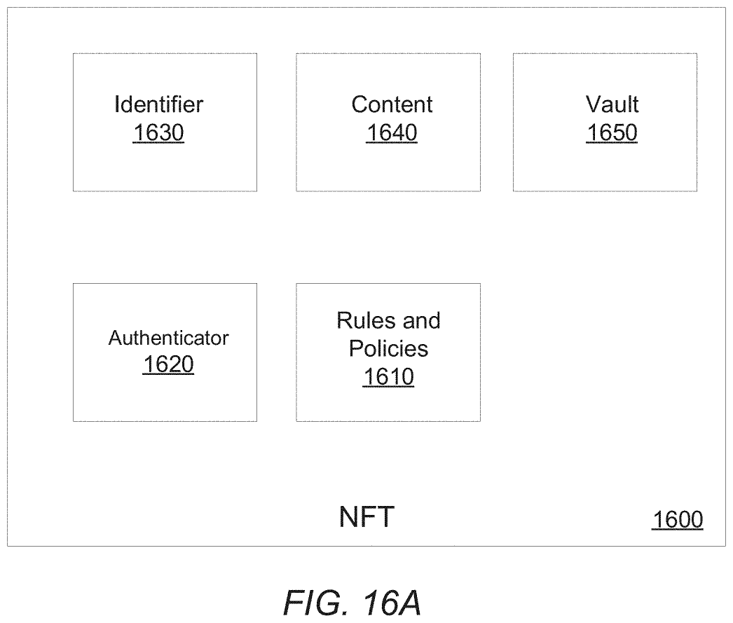

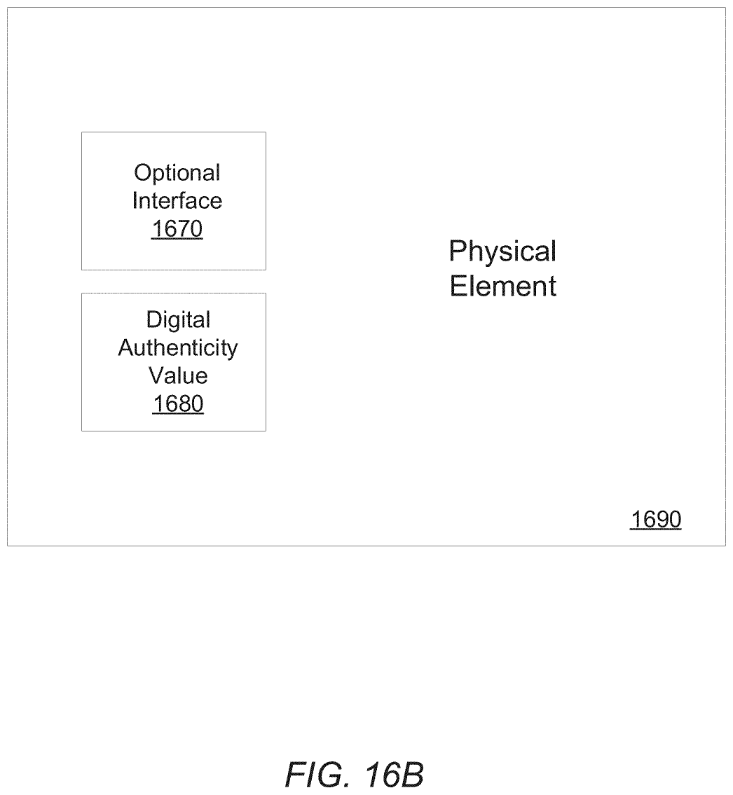

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

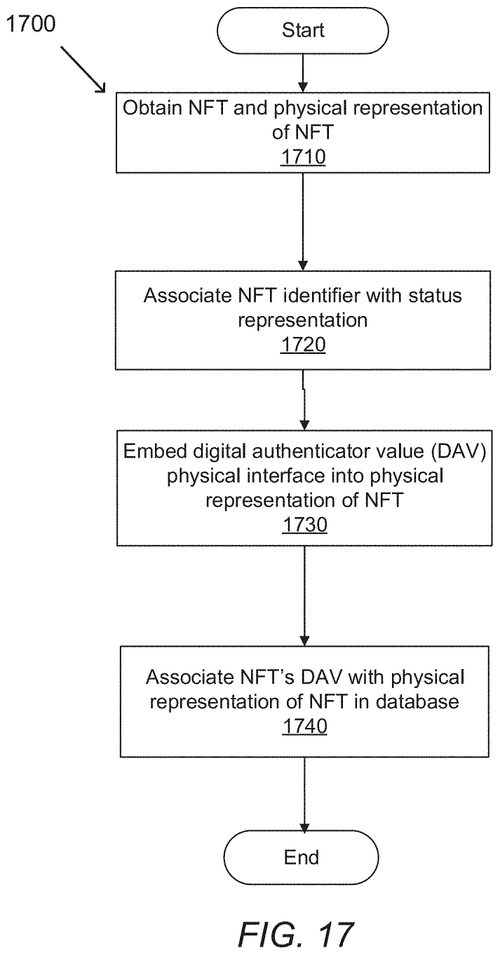

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### Conditional Transaction Tokens

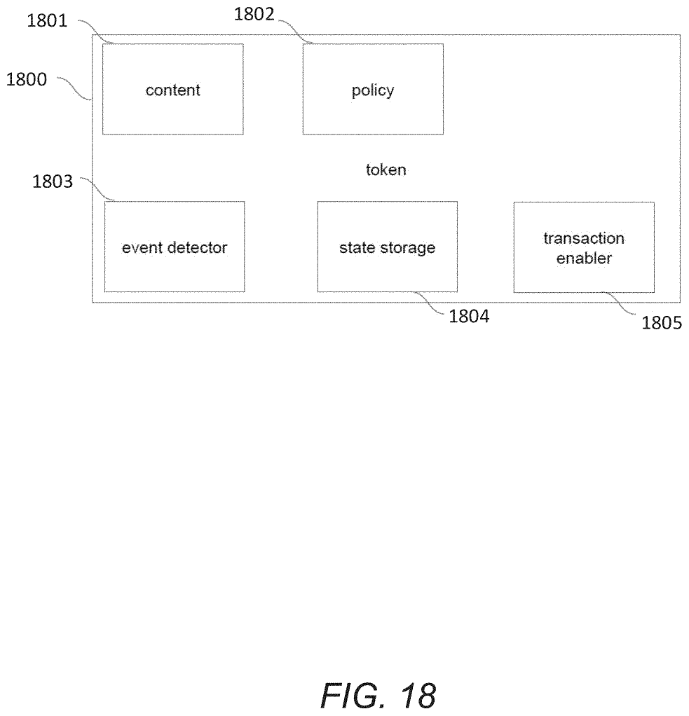

In various embodiments, tokens can include policies controlling ownership and transfer rights. An example of a token including an embedded policy for controlling ownership and transfer rights is conceptually illustrated in FIG. 18. A token 1800 includes content 1801, at least one policy 1802, an event detector 1803, a state storage 1804, and a transaction enabler 1805. In several embodiments, content can include songs, movies, soundtracks, captions, pieces of software, graphical elements, game components, and/or a combination of such types of data. In many embodiments, policies can specify conditions and outcomes. Conditions can correspond to data that can either be internally observed (e.g., as a user interacts with a token), or can come from an external source and be conveyed to a token over a network (e.g., by an application). In various embodiments, state storages can store data corresponding to observed events (e.g., measurements). Observed events can be stored external to a token that includes the state storage. Data stored in state storage can be authenticated, and/or encrypted. In several embodiments, transaction enablers can be external to tokens. In a number of embodiments transaction enablers perform actions when conditions associated with policies are satisfied. In various embodiments, conditions can be satisfied based on detections of events by event detectors. In many embodiments, conditions can be satisfied based on determining that state storages stores indications that correspond to events matching the conditions of policies having taken place. In many embodiments, actions taken by transaction enablers can include (but are not limited to) making token functionalities available (e.g., enabling access to at least portions of content to a holder of token, or to a potential acquirer of the token), can enabling transactions associated with tokens, and/or other actions. In many embodiments, state storages can store information about content, about the token owners, and/or about available transactions that can be performed on tokens.

In some embodiments, items (e.g., physical and/or virtual) can be allowed to be transferred to a new public key, and/or grant access rights at least some of the time. Access to the ability to transfer the item can be based on a condition. In various embodiments, ownership includes access rights. In many embodiments, access rights do not include ownership. In certain embodiments, an owner of a digital item can be allowed to provide access to anybody he or she wishes, can be limited by the originator of the item to provide access to up to a number (e.g., 10) of people, and/or to nobody at all. In some embodiments, owners can transfer the ownership of items to other parties, either temporarily, or indefinitely. In many embodiments, a token originator can set the token to include policies which control and/or limit how transfers of ownership are performed.

In various embodiments, one or more policies can be associated with items. Policies can govern the actions that can be applied to the item. Actions that can be governed include (but are not limited to) the transfer of ownership and/or provision of access rights. In various embodiments, the policy can state that an item cannot be transferred within a period of time (e.g., one year) of the time when it was first obtained by the first owner, but that it can be freely transferred at any time after this point in time. In certain embodiments, policies can state the countries to which the item can be transferred, or not transferred. Potential acquirers can be associated with a country. Potential acquirers can also be associated with other descriptive elements, such as dates of birth, and policies can specify minimum or maximum ages of the acquirer. Policies can have policies based on descriptive elements associated with potential acquirers.

In some embodiments, policies enable fungible transfers of ownership and access rights. In many embodiments, acquirers of virtual items can have full rights to the item. Full rights to an item can include the right to enable any number of users access to the item. Policies of items can specify that an owner of the item can modify the policy in one or more pre-specified manners. For example, an owner of the item can have full rights to provide access to any number of users, and/or can sell the item to another party that then has the same rights, and/or the owner can sell the one item to two parties, each one of can have degraded rights. Degraded rights can include being limited to provide access to at most 100 users at any one point in time. These degraded rights can be referred to as the first-time degraded rights. The owners can resell the item with the same first-time degraded rights, to exactly one buyer, and/or it can resell the item to two buyers with second-time degraded rights, which can specify that each of the new owners can provide access to at most 40 users at any point in time. In several embodiments, the original policy can specify how the items, and or policies can be modified. For example, a transfer of ownership or access rights can include an additional payment, surcharge, sales commission, or royalty, such as when a music fan gives, or sells a digital music file to another music fan—per the item's stated policies.

In some embodiments, an entity provides a new Non-Fungible Token (NFT) based on a transaction. The transaction can include a transfer of value. In various embodiments, the NFT provided can be replaced after a period of time (e.g., each week) to provide a new NFT to NFT receivers the next time period, and yet another one to customers in two time periods, etc. These periodic NFTs can look different from each other and/or have different functionality.

In several embodiments, after a time period, NFTs can have different personalizations. Personalizations can include different sequence numbers based on the order in which qualifying transactions took place. Different personalizations can impact the appearance and/or functionality of NFT items. In several embodiments, NFTs can have policies associated with them. In various embodiments, policies can state that for one year, an associated NFT can only be shown to a total of 1000 people over course of the year, and/or that the NFT cannot have its ownership modified until after the end of that one year. In some embodiments, policies can state that an associated NFT can only be sold if the purchase price exceeds a minimum amount (e.g., $50), and that if the NFT is sold for more than a threshold amount (e.g.,$10000), then a percentage (e.g., 5%) of the purchase amount goes not to the seller of the NFT but to a pre-specified public key and/or entity (e.g., a charity). In many embodiments, policies can apply only to the first time the NFT is sold, only after having been first acquired and kept for a year, and/or policies can apply to a set number of such transactions, and/or all transactions involving the NFT. In certain embodiments, policies can be stored with the NFT in question, and/or in a digital rights management (DRM) token associated with the NFT. The DRM token can include keys to access the NFT, verify its authenticity, and/or perform actions related to it. In some embodiments, the same DRM token can house the one or more policies.

In various embodiments, policies can be associated with virtual items (e.g., NFTs) and/or physical items. Methods for ascertaining authenticity and ownership of items are described in U.S. Provisional Patent Application No. 63/019,178 filed May 1, 2020 titled “Ascertaining Authenticity and Ownership Using Interactive Identity Tags” by Markus Jakobsson. In some embodiments, policies can be stored in repositories that associate items with ownership information. In several embodiments, policies can be stored separately, such as on a blockchain, where they are used by the owner to provide evidence of ownership to third parties.

In various embodiments, policies can be modified based on events. Events can include transfers of ownership. In several embodiments, transfers of ownership can trigger modifications of policies. In various embodiments, purchase prices exceeding threshold values can trigger modifications of policies. Various events can trigger modifications of the policy. In some embodiments, triggering actions can include user-actions related to an item, such as having been interacted with in a pre-specified manner or having been viewed by a threshold number of users, such as 100,000 users. In some embodiments, triggers are a priori known, or at least knowable, by owners and/or non-owners. In many embodiments, at least some of the parameters of a policy are protected so that they are not available to an owner and/or other parties. In various embodiments, the protection of policy parameters can enable surprise evolution of appearance, functionality or other aspects associated with a virtual item, such as an NFT. In many embodiments, the surprise can come from the protection of the parameters governing the policy. In certain embodiments, the surprise aspect can be due to the influence on the functionality by a random or pseudo-random value that is accessed by or in conjunction with use of the NFT. In many embodiments, events can be external events, external to a device storing or accessing an NFT. External events can include information recorded on a blockchain. Events can be internal event, such as using inputs on a device storing or accessing the NFT. In certain embodiments, policies can store (e.g., in the policies themselves, and/or in an associated storage), state information related to events that have taken place and/or which could affect the policy. State information can be stored in the same token or tokens that store the NFT, the policy, and/or DRM-related information for the NFT. The techniques described herein can be applied to both NFTs and digital items that are not NFTs (e.g., digital items with a fungible nature). In some embodiments, NFTs can be upgradable, such as an expansion of capability, pursuant to an accomplishment, such as in a gaming environment, and/or a purchase by the NFT licensee. In various embodiments, NFTs can be renewable monthly, or annually to represent a subscription of sorts, such as for access to accounting software tools, etc.

While specific systems and components for tokens including an embedded policy for controlling ownership and transfer rights are described above, any of a variety of systems and components can be utilized for tokens including an embedded policy for controlling ownership and transfer rights as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to tokens including an embedded policy for controlling ownership and transfer rights the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

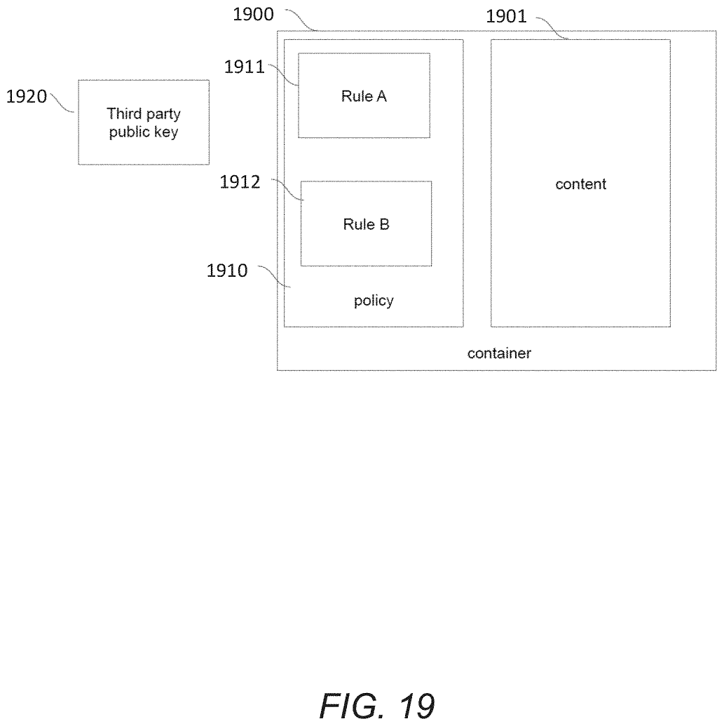

In several embodiments, token-embedded policies enable original creators (e.g., original artists) to gain royalties from a secondary sale. An example of a container (e.g., a token) for enabling original creators to receive tokens from a secondary transfer is conceptually illustrated in FIG. 19. A container 1900, can include content 1901 and policy 1910. Policy 1910 can include two rules, rule A 1911 and rule B 1912. In various embodiments, rules can specify that when containers have changes of ownership rights, a third party corresponding to third party public key (e.g., third party public key 1920) can be included in a transaction. In a number of embodiments, rules can indicate that the third-party public key must sent a transfer (e.g., must be paid $1 in a specified currency, such as BTC, or 5% of the sales amount, whichever is greater). In some embodiments, rules can specify that new owners can provide access to content to a threshold number of users, but that providing access to a number of users exceeding a threshold can require a transaction including a third-party public key. For example, Rule B 1912 can specify that a new owner can provide access to the content 1901 to up to 5 users without charge, but for any additional users given access to content 1901, a payment of $0.01 must be made to an entity corresponding to third party public key 1920. While specific systems and components for a container (e.g., a token) for enabling original creators to receive tokens from a secondary transfer are described above, any of a variety of systems and components can be utilized for a container (e.g., a token) for enabling original creators to receive tokens from a secondary transfer as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a container (e.g., a token) for enabling original creators to receive tokens from a secondary transfer the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

In several embodiments, tokens can include token policies. The token policies can enable a change associated with a token in response to a condition. In various embodiments, the changes can be referred to as state changes. Triggers can be referred to as conditions (e.g., satisfied conditions). In various embodiments, a condition can include the token having been associated with the same public key for more than a threshold duration. In some embodiments, a change can include a change to an artwork. In various embodiments, token policies can trigger additional layers of artwork evolution based upon ownership of the token for at least a threshold duration.

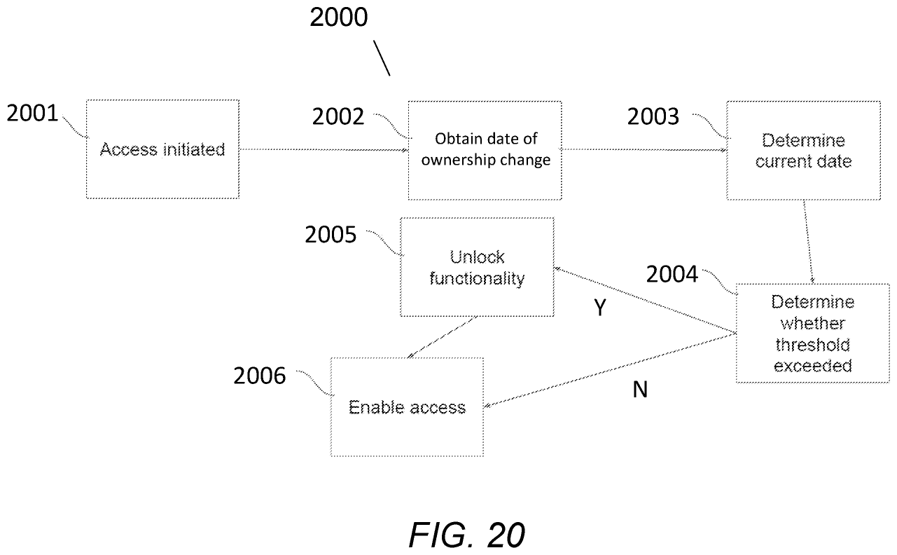

An example process for unlocking token functionality based on a threshold duration is conceptually illustrated in FIG. 20. A process 2000 can initiate (2001) access to content. In various embodiments, access can be initiated by an app. The process 2000 can obtain (2002) a date of the most recent ownership change. In many embodiments, the date of most recent ownership change can be stored in state storage and/or can be accessed from a blockchain on which transactions are recorded. The process 2000 can determine (2003) the current date. In various embodiments, determining the current date can be done using an oracle, by reading a date stamp on the most recent ledger, by using a universal trusted resource, and/or based on the system clock of a trusted execution environment (TEE) in which at least some of the computation of an associated process (e.g., process 2000) is performed. The process 2000 can determine (2004) whether the current date differs from the most recent date of ownership change by at least a threshold amount. In various embodiments, the threshold amount can be denominated in days. In a number of embodiments, the threshold number of days can be stored in optional state storage (e.g., storage 1804), be part of a rule, and/or be part of a policy (e.g., policy 1802). When the threshold is exceeded (e.g., the content has been owned for a period of time that exceeds the threshold) the process 2000 proceeds unlock (2005) additional functionality. In many embodiments, the additional functionality can include access to a new feature, or enablement of a new type of transaction. In certain embodiments, new functionalities and/or abilities can be triggered by various types of rules and/or policies, and not only a sufficient period of ownership, as shown in this illustrative example. The process 2000 can access (2006) the content after the unlocking additional functionality. When the threshold is not exceeded, the process 2000 can access (2006) the content. In several embodiments, there can be additional verification of access rights (not shown in the figure).

In many embodiments, an item owned by a first entity (e.g., first entity associated with a first public key) can be modified based on a second item being owned by the first entity. In several embodiments, multiple items can, when owned by the same entity, automatically change at least one property associated with the items. In various embodiments, the items can be NFTs. In some embodiments, the items can be various virtual items (e.g., virtual items in a game). In many embodiments, items can be physical items (e.g., a set of related playing cards with associated ownership data recorded in a database). In various embodiments, a modification can be performed to items based on conditions. In some embodiments, the qualifying condition can be fulfilled when a set of items are all owned by the same entity and/or another condition is satisfied. In certain embodiments, the modification can trigger a change to privileges. A change to privileges can include changes to how many people can access the content; changes to access to aspects of the content. For example, a game can include multiple NFTs forming a set, each NFT corresponding to some aspect of the game. The NFTs can be configured such that when all NFTs in the set are owned by the same entity, there can be a transformation. Transformations can include at least one of the items can provide a modified functionality. The modified functionality can include elements to allow users access to a new level, or to some virtual goods.

In a number of embodiments, there can be other triggering conditions as well. Triggering conditions can include when a majority of NFTs of a family are owned by one and the same entity. In several embodiments, the satisfaction of triggering conditions can enable new functionalities. New functionalities can include access to Easter egg like functionality in games. New functionalities can include access to new levels, new access rights, financial rewards, or other functionalities as governed by rules and/or policies associated with NFTs. In several embodiments, the presence and/or nature of changes can be publicly available (e.g., be known a priori by users), can be hidden until the changes are triggered, or can be partially hidden and partially publicly available. In some embodiments, the changes can also be hidden even after they are made available, and only discoverable by one or more events taking place, but which would not have enabled the new functionality prior to the triggering condition being satisfied.

In various embodiments, families can correspond to different items (e.g., elements) in a game. The family can relate to a collection of related items. The collection of related items can be, for example, a collection of virtual swords. In various embodiments, families can correspond to a series of NFTs that are the same or similar, and/or which are grouped into a family by the originator. In many embodiments, grouping elements into families and associating triggering conditions with the families can be performed by originators. In certain embodiments, parties with sufficient access to all of the items (e.g., elements) can group NFTs into families. In various embodiments, entities that own a number of (e.g., 10) different NFTs can group the NFTs into families, decide whether or not to make public which items (e.g., elements) belong to the family, and/or associate one or more policies with the items (e.g., elements) of the family. In many embodiments, policies are used to determine whether conditions are satisfied, and if so, to trigger an event. Conditions in accordance with some embodiments of the invention can include contemporaneous ownership of all members of the family, a threshold number of members of the family, an external event (e.g., an external event that is detectable in the execution environment wherein at least one of the items reside) and/or a combination of such events. In some embodiments, conditions can be publicly knowable, e.g., advertised and accessible to parties with at least partial access to NFTs (or other element) of the family. Conditions in accordance with some embodiments of the invention can be hidden to users and/or only made accessible when the condition is satisfied.

In various embodiments, tokens can be associated with conditions. Conditions can be implemented as rules or policies. Conditions, rules, and/or policies can govern functionality related to tokens. In various embodiments, functionalities include (but are not limited to) abilities to transfer ownership, functionalities of tokens; accessibility of token aspects, accessibility to hidden content, rewards and/or rights associated with tokens. In several embodiments, any of the various functionalities described herein can be applied to groupings of tokens (e.g., tokens owned by the entity, tokens of a certain type and/or family, tokens containing one or more policies, tokens fitting into a group based on token characteristics). In various embodiments, the methods and systems applied to tokens can also be applied to items. In several embodiments, triggering conditions can be implemented by rules and/or policies, where the triggering conditions govern the functionality associated with the tokens. In many embodiments, tokens include NFTs, tokens are not limited to NFTs. Various examples of tokens are described U.S. Provisional Patent Application No. 63/213,251 filed Jun. 22, 2021 titled “Token Creation and Management Structure,” and U.S. patent application Ser. No. 17/808,264 filed Jun. 22, 2022 titled “Systems and Methods for Token Creation and Management” by Markus Jakobsson and Stephen C. Gerber, the disclosures of which are incorporated herein by reference in their entireties. In certain embodiments, policies can be publicly readable independent of whether they have been triggered. In some embodiments, policies, including their triggering contexts and change in functionality due to triggering, can be hidden and only made available to select users with sufficient access rights, or only under pre-specified conditions.

In certain embodiments, tokens can determine whether policies are triggered by the context (e.g., execution context) when the policy is evaluated. In some embodiments, policies can be evaluated when tokens are accessed. In some embodiments, evaluation of policies can be outsourced to another process that periodically determines whether any conditions related to tokens are satisfied. In several embodiments, conditions for triggering functions can be external. External triggering conditions can include triggering signals (e.g., wake-up signals) from content originators and/or triggering signals from off-chain authorities (e.g., oracles). In many embodiments, triggering conditions can be internal (e.g., generated on a device associated with the device where the token is stored or used). In various embodiments, apps used to render content related to tokens can be used to periodically determine whether conditions are satisfied for one or more tokens. In some embodiments, an apps can check conditions on tokens when given token information about the tokens, and by accessing the policies of the tokens. The token information can be stored. In many embodiments, stored information can include a list of owned tokens, as well as descriptors of external events (e.g., broadcasts from token originators). In several embodiments, token originators can send information that can be used to unlock functionality associated with one or more tokens. In various embodiments, the unlocking process can require additional information from the originator or a party associated with the originator. For example, the originator can request anonymized usage information, anonymized trading information, influencer sales information, or other similar data in order to provide unlocking material. Thus, the unlocking mechanism can serve as an incentive for end-users to provide some limited usage information to external parties, such as content originators, which in turn incentivizes originators and other third parties to associate policies, triggers and added functionality with tokens. One example type of token is an NFT.

In several embodiments, ownership control can be managed using policies associated with tokens. In many embodiments, exchange determine, based on policies associated with tokens, whether the token can be transacted. In certain embodiments, tokens can include references to registry elements. Registry elements can include ownership information, such as a public key of the owner. In several embodiments, registry elements can only be updated conditional on transfers being allowed by policies associated with tokens. In many embodiments, executable elements associated with tokens can have functionalities that are conditional on policies being satisfied. For example, it can be impossible to verify the authenticity of tokens unless policies are satisfied. The policy conditions can be satisfied based on information associated with owners and prospective owners. Ownership change control can be performed in other ways, as will be understood by a person of skill in the art.

While specific processes for unlocking token functionality based on a threshold duration are described above, any of a variety of processes can be utilized for unlocking token functionality based on a threshold duration as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to unlocking token functionality based on a threshold duration the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

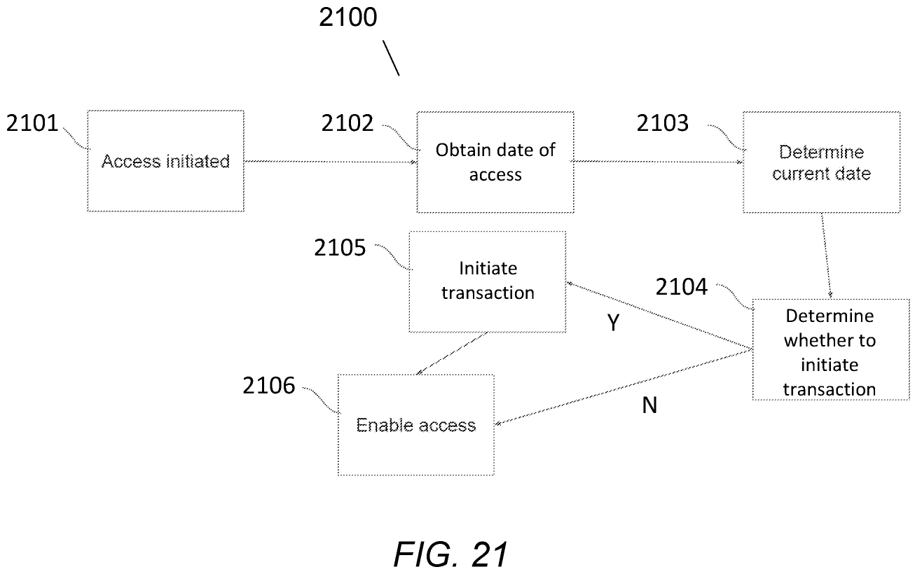

In some embodiments a token policy can an ongoing monthly subscription to a product, service, or artwork. An example process for initiating a transaction in response to content being accessed is conceptually illustrated in FIG. 21. In an illustrative example, a user has acquired a license to access the content, where the license can specify that the user pays $0.05 per month for having access to the content associated with the policy. A process 2100 initiates (2101) access to content. The process 2100 obtains (2102) the date of a content access (e.g., a most recent access). The process 2100 determines (2103) a current date (e.g., in a manner as described elsewhere herein) The process 2100 determines (2104) whether to initiate a transaction or not. Determining whether to initiate a transaction or not can be based on the current date and the date of content access. In some embodiments, determining whether to initiate a transaction or not can include determining whether a payment is due (e.g., if a new billing period has been entered based on a billing schedule that can be stored as part of policy or in state storage). When it is determined that a new transaction should be initiated the process 2100 initiates (2105) the transaction. In some embodiments, transactions can include payment for subscription charges. Processes can include optional messaging steps that can notify users of charges. When it is determined that the transaction is not to be initiated and/or after initiating (2105) the transaction the process 2100 can continue to enable (2106) access to the content. In some embodiments, there can be additional verification of access rights (not shown in the figure).

While specific processes for initiating a transaction in response to content being accessed are described above, any of a variety of processes can be utilized for initiating a transaction in response to content being accessed as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to initiating a transaction in response to content being accessed the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

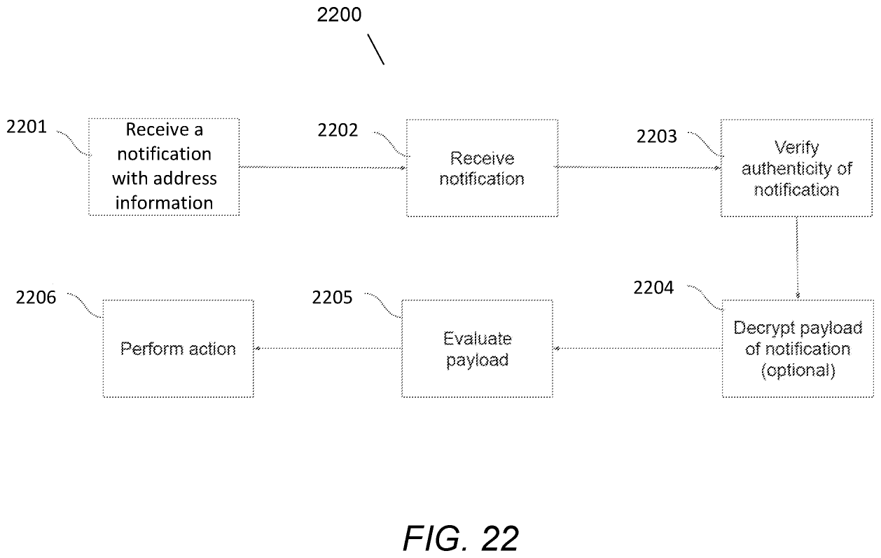

In some embodiments, a signal (e.g., a wake-up signal) from a content originator can enable actions, features, and/or changes associated with a token. In various embodiments, wake-up signals can trigger re-renderings of artworks with additional layers of functionality. An example process for performing actions based on a wake-up signal is conceptually illustrated in FIG. 22. In various embodiments, the process 2200 can be executed by miners and/or verifiers. A process 2200 can receive (2201) address information (e.g., public keys) related to a token. The address information can include address information for a third party. In various embodiments, the third party is a marketplace, a content originator, or another party. In some embodiments the third party can be involved in transmitting notifications. In various embodiments, address information can be transmitted as part of a transaction. Transactions can be immutably recorded on distributed ledgers. In many embodiments, transmission of the address information can be included as part of a transaction for acquisition of ownership of a token (e.g., the token), or of access rights to content associated with a token.

A process 2200 can receive (2202) a notification. The notification can be a transaction with a recipient defined by the address information. In some embodiments, the notification can be a transaction broadcast for incorporation to a ledger entry. The notification can be received at the address associated with step 2201. The process 2200 can verify (2203) the authenticity of the notification. Verifying the authenticity of the can be performed by evaluating a digital signature, by evaluating a message authentication code (MAC), and/or by performing a verification related to a sender phone number (e.g., using STIR/SHAKEN or similar techniques used for authenticity verification). In several embodiments, when the notification cannot be determined to be authentic, then the process can halt or otherwise branch to a step not illustrated. The process 2200 can determine (2204) whether the payload is encrypted and/or decrypt a payload associated with the notification. The process 2200 can evaluate (2205) the payload. In some embodiments, processes can determine whether instructions associated with the payload apply to the content associated with the token. The process 2200 can perform (2206) an action. The action performed can be based on the payload. In various embodiments, the performance of the action includes the generation and broadcasting of a transaction. An example action is to enable a new feature associated with the content. Another example action is to request confirmations from entities performing the processing access evaluations, where the confirmations can include usage data, and/or log detailing access statistics. In some embodiments, transmission of usage can trigger access to additional features. For example, additional features can be enabled for a content element that has been viewed at least a number of time (e.g., ten times) but not if the content element has been viewed fewer than ten times. In several embodiments, determinations can be performed by external parties, and/or other entities.

In various embodiments, access rights can be managed using policies. Access rights can be granted to more entities than ownership rights. For example, more users can be allowed to access the content associated with the token in a pre-specified manner than what corresponds to the ownership group. The ownership group can include one or more users. In many embodiments, there can be different types of access rights. Different types of access rights can correspond to different limits or constraints. In some embodiments, limits and constraints can be governed by policies associated with tokens. In certain embodiments, tokens can include one or more content elements. Each of the one or more content elements can be can be associated with distinct policies. In some embodiments, elements can movies, soundtracks in languages (e.g., English, Spanish, French), and/or captions in languages. In some embodiments, different content items can each one be associated with different access rights, governed by different policies, which can be specified by content producers. In some embodiments, content producers can create a particular e.g., English-language version of the movie, that can be accessed within a pre-specified time interval under pre-specified conditions. In various embodiments, conditions can include the estimated locations from which the content is attempted to be accessed, minimum prices the accessor pays, and/or minimum commissions, fees, or royalties of the price that content originator are provided as result of access. In several embodiments, a different language version (e.g., the Spanish-language version) of the same movie can be governed by other policies. This can enable segmentation of the market in a manner that is desired by the content originator. In several embodiments, policies can also be added by a non-content originator entity (e.g., a middleman), where allowed by the content originator. Middlemen can be entities, such as a distributor, that can add constraints by adding policies to the pre-existing policies. In various embodiments, all policies can be required to be satisfied for a user to access content. In several embodiments, not all policies need to be satisfied. In some embodiments, at least a number (e.g., 1, 2, 3, 4, or another number) of policies need to be satisfied. In various embodiments, these rules and/or policies can be specified by the content originator.

In several embodiments, content can act at first as a rental (e.g., of a movie), that can be viewed only a limited number of times within a limited period of time after first being acquired, but which then (e.g., after a year), can allow any number of accesses by the one or more parties that performed the accesses in the first time period (e.g., as determined by the bonding of the movie at the time of the first viewing with a public key to which a user needs to prove knowledge of the corresponding secret key). This is a useful type of contract that is not currently made possible by existing structures, but which is enabled by the conditional access policies.

While specific processes for performing actions based on a wake-up signal are described above, any of a variety of processes can be utilized for performing actions based on a wake-up signal as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to performing actions based on a wake-up signal the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

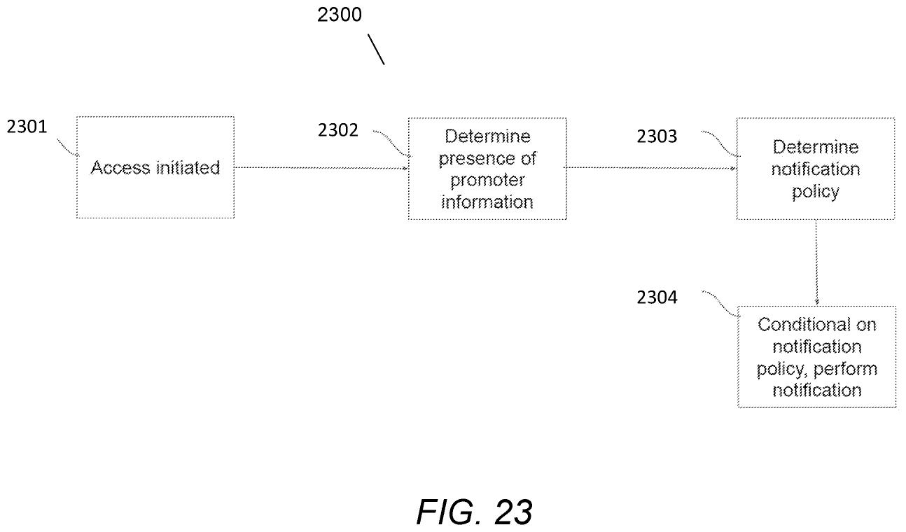

In several embodiments, influencers can make modifications to items, and influencers can receive transactions related to the items. An example policy-based payment to a successful influencer is conceptually illustrated in FIG. 23. A process 2300 can initiate (2301) access an item (e.g., such as a token, and/or a container). The process 2300 can determine (2302) whether one or more promoters are associated with the token or container. In various embodiments, promoters can include influencers and advertisers. When one or more promoters are listed, then process 2300 can determine (2303) whether one or more of the promoters are associated with a notification policy. The notification policy can be part of a policy associated with an item. Conditional on one or more of the promoters being associated with a notification policy, the process 2300 can generate (2304) one or more notifications for transmission to the one or more promoters. In certain embodiments, when there is a policy associated with a promoter, and the promoter is associated with an item then a third-party information collector can be notified of access associated with the item. In several embodiments, this can enable a record associated with the conversions of the promoter identified in the notification to be made by the third party. Thus, content originators can be able to determine the influence wielded by various promoters and award them accordingly. In various embodiments, third-parties can be associated with the brand (e.g., content originator), or with the promoter, or both. In several embodiments, multiple third parties can be notified. One or more of the third parties can generate reports to brands and/or promoters, where these reports can help them identify what campaigns are successful and which ones are not. Notifications can be used to validate billing events collected in other manners (e.g., from payments directly made by execution environments accessing tokens).

In various embodiments, an influencer structure can be created, wherein a first party, referred to as the influencer herein, acquires the content. In some embodiments, the content can be part of a token. Tokens can be associated with policies indicating amounts that have to be paid when new users acquire access rights to content of respective tokens. In several embodiments, access can be limited (e.g., to five times by one and the same device). In some embodiments, access can be associated with a price (e.g., $1, and/or corresponding amounts in crypto currency). In various embodiments, influencers can add second policies to items, tokens, and/or content that apply to a token derived from another token. Influencers can derive new tokens based on original tokens by additions of second policies. In several embodiments, second policies state that every time users acquire derived token, a payment (e.g., $0.01, or crypto currency equivalent) can be due to the influencer. Influencers can distribute access to derived content to fans. When derived content is accessed the originator (e.g., of the original content on which the derived content was based) can be paid a first amount (e.g., paid $1) and the influencer can be paid a second amount (e.g., paid $0.01). In several embodiments, influencers can sell the token. In some embodiments, when a receiver receives a derived token, can promote the content it to yet other users, and add can add a third policy. In various embodiments, third policies can state that every time the movie associated with the token is transferred, the transferor and/or transferee can be required to take an action or view some content (e.g., must watch a 20-second advertisement that is shown as the movie is downloaded). The policy creating entity can receive transactions (e.g., payment) based on the transferor and/or transferee having been required to take an action or view some content) payment. The payment can be independent of the price the new buyer pays.

In several embodiments, when a buyer acquires access to content of multi-derived (e.g., twice-derived) tokens, content originators can receive transactions (e.g., payment, $1), influencers can receive transactions (e.g., payment, $0.01), and other previous owners can be paid bounties (e.g., $025) associated with a given advertisement. In many embodiments, policies can include changes to transaction characteristics (e.g., payment amounts). Changes to transaction characteristics can be based on policies associated with creators, influencers, and/or previous owners. Various features of policies can be hidden until a condition is satisfied.

In an example, an originator can have a policy stating that its payment goes down to $0.25 ten months after the initial release of a movie. This can enable the price to be dropped. If Bob buys the movie from Alice a week after its release, and resells it ten months after the release then the buyer, say Charlie, will have to pay an amount that exceeds $0.26, since the originator needs to be paid $0.25 and the influencer must be paid $0.01. Bob can still sell it for $1.01, which would allow him to pocket the difference.

In several embodiments, containers correspond to stored elements that include one or more tokens. Containers can include tokens that are associated with one and the same family of tokens, as specified by a content originator or aggregator. Tokens can be associated with multiple containers. Containers can be associated with access rights or units that can be used to render it.

While specific systems and components for policy-based payment to a successful influencer are described above, any of a variety of systems and components can be utilized for policy-based payment to a successful influencer as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to policy-based payment to a successful influencer the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

### Secure Sharing of Token Assets

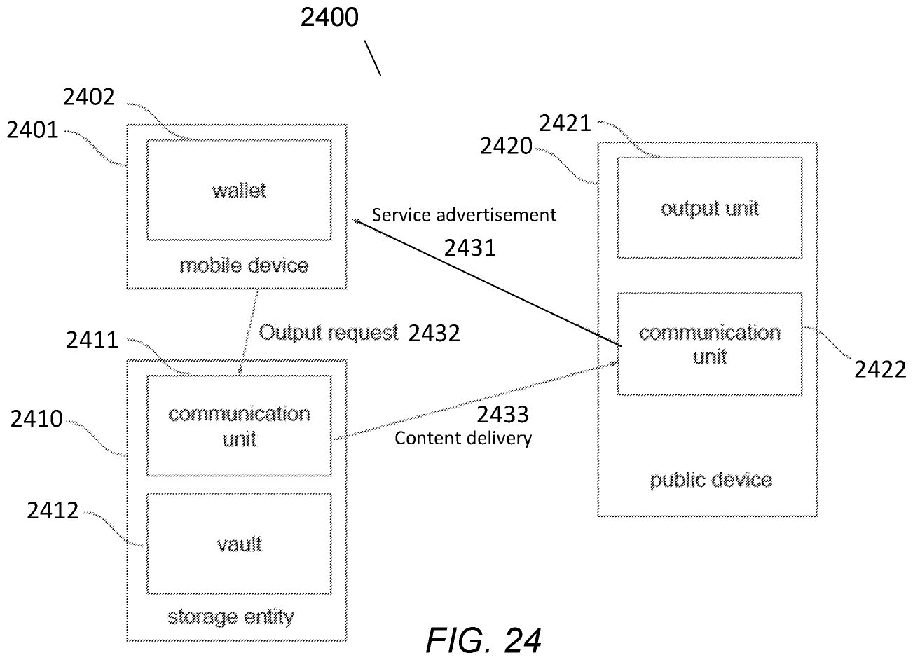

In various embodiments, secure sharing is performed in the context of a secure sharing architecture. An example embodiment of a secure sharing architecture is conceptually illustrated in FIG. 24. A secure sharing architecture 2400 can include a mobile device 2401. The mobile device 2401 can receive a service advertisement 2431. The service advertisement 2431 can be sent from a public device 2420, via a communication unit 2422. The mobile device 2401 can have an interface as part of a wallet 2402. In various embodiments, end-users can use wallets to send requests to display content elements on public devices. Wallets can render visual indications of the presence and capabilities of public devices. Presences and capabilities of public devices can correspond to service advertisements. In various embodiments, requests to display can be performed conditional on requirements being satisfied. In some embodiments, public devices can have security certifications that meet required standards of wallet and content to be displayed (not shown). In several embodiments, mobile devices can convey output requests (e.g., output request 2432). The output request 2432 can be received to a communication unit 2411 of a storage entity 2410. In various embodiments, a storage entity can be part of a mobile device (e.g., mobile device 2401) or can be separate (e.g., as shown in FIG. 24). Storage entities can verify that public devices satisfy one or more conditions set by wallet users, and/or one or more conditions associated with the selected content to be output on output units (e.g., output unit 2421) of public devices (e.g., public device 2420). Conditional on the requirements being satisfied, storage entities can access the selected content from a vault (e.g., a vault 2412), create a secure container including data related to the selected content and/or transmit the secure container from communication unit (e.g., communication unit 2411) of storage entity (e.g., a storage entity 2410) to a communication unit (e.g., communication unit 2422) of a public device (e.g., public device 2420). Communication units can forward encrypted data to output units. Output units can decrypt, process and/or render data. In various embodiments, rendering can include displaying on a screen or similar projection device, sending to a speaker, processing on one or more processors, and/or a combination of such actions. In several embodiments, output units can prepare logs, including usage data, and/or later cause usage data to be transmitted to storage entities (e.g., storage entity 2410).

In various embodiments, a first device including a wallet or other token storage unit can connected to an output unit. Output units can include (but are not limited to) terminals, TV screens, loudspeakers, headphones, actuators, engines, heaters, and/or other components. Output units can have sensors. Sensors can include touch sensors (e.g., touch screens). Output units can be part of the first device. In a variety of embodiments, when output units are not physically connected to or part of the first device, then a secure connection can be established between the first device and the output unit. In a number of embodiments, secure connections can be encrypted and authenticated connections (e.g., secure channel). In some embodiments, secure connections can be encrypted but not authenticated, or authenticated but not encrypted. Secure connections can be established over radio connections (e.g., Bluetooth Low Energy (BLE) connection), WiFi connections, Zigbee connections and/or other connection means. In several embodiments, similar secure connections can be used for service advertisements. In many embodiments, secure connections can be established between wallets and trusted execution environments (TEEs) associated with output units. TEEs can be certified using digital certificates generated by trusted authorities. In several embodiments, content can be transmitted to TEEs of output devices if and only if the certificate meets or exceeds a threshold requirement of security (e.g., the certificate authority asserts that the TEE has a security level that is 9 out of 10 and the threshold requirement is a score of 6). In many embodiments, verifications of certificates can entail verifications of whether certificates have been revoked (e.g., by accessing a certification revocation list (CRL) to determine the validity of the certificate).

In some embodiments, certificates can include information related to one or more classifications. Examples of classifications include (but are not limited to) identifiers of operating systems of output devices, types of malware protection associated with certificates, manufacturers of TEEs, and/or other classifications. In a number of embodiments, tokens can be displayed and/or otherwise rendered on output devices that meet and/or exceed requirements set by content originators (e.g., content creators) or parties associated with the same (e.g., distributors, agents, media houses, and/or promoters.

In various embodiments, output units can advertise output unit parameters to devices with wallets. Advertising output unit parameters can be performed by transmitting (e.g., using wifi or BLE) one or more packets indicating the type of services supported by the output unit, an identifier of the output unit, and/or a security description related to the output unit. In various embodiments, example services supported include (but are not limited to) the rendering of images, support for AI-based interpolation techniques, particular software packages (e.g., Microsoft Excel™), the presence of a specified physical user interface such as a keyboard or a pointing device, stereo output for audio, the presence of a DRM unit supporting a specified standard, heating control, motor control, electrical circuit control, control signals, and/or other services. In a number of embodiments, the identifier is a public key. In various embodiments, the identifier is a MAC address. Security descriptions can include one or more scores or ratings and/or one or more certificates. The certificates can be associated with data (e.g., content) of the one or more transmitted packets. In several embodiments, recipients of service advertisements can determine which tokens and/or content elements are compatible with output units associated with the service advertisements. In several embodiments, for all available tokens and/or content elements, it is determined which tokens and/or content elements can be processed on the one or more output units corresponding to the one or more service advertisements. In several embodiments, user interfaces (e.g., wallet user interfaces) can include visual indications of compatibility between output units, and tokens and/content elements. Visual indications in accordance with numerous embodiments of the invention can be included for all of the elements that can be processed. In various embodiments, users can obtain more information by hovering over visual indications. Hovering over visual indications can result in popups describing output devices, any fees needed to be paid to use it, and/or whether the output device supports all functionality of the indicated content element or only some such functionality. In various embodiments, multiple indicators can be listed for each element. The indicators can be ordered in manners indicating likely preferences of users (e.g., preferences of users for one output device over another output device, and/or preferences for users based on past user behavior).

For example, Alice may always choose the highest-fidelity output unit while Bob may always choose the one with the lowest usage fees. Therefore, for Alice, device A can be listed first as being able to render content A, with device B as a second choice. Displaying content A on device A may cost $0.10, but device A has twice the resolution of device B, for which displaying is free. For Bob, device B is listed first for content A, and device A second. Bob also has content B. This can be rendered on device A, but not on device B, due to security requirements associated with content B that are met by device A but not by device B. Therefore, for Bob, content B is indicated as being playable on device A. When Bob does a mouse-over for this indication, he is informed in the popup that there is a cost of $0.10 for rendering content B on this device.

In various embodiments, content (e.g., content A, and/or content B), can correspond to tokens (e.g., NFTs). In some embodiments, content can include content that is encrypted (e.g., using a content delivery key), content that is not encrypted, content that is owned by the user whose wallet is rendering information about the content, and/or more types of content.

In several embodiments, several output units can be available to users simultaneously. Output units can be free to use, and/or require fees to be used. In several embodiments, output units can have some free usages, while some services can have a cost. For example, one output device can be free to use as a display, but has a charge when some software package (e.g., Microsoft Excel™) is used in conjunction with the display functionality.

In various embodiments, advertising of services can look similar to how WiFi access is advertised by hotspots. In some embodiments, advertising of services can be presented in an application (e.g., an application on a mobile device, and/or a special-purpose application) used to select services. Applications to select services can be user wallets. In many embodiments, user wallets can be configured to remember user's previously expressed preferences. Previously expressed preferences can include explicitly expressed preferences (e.g., in the form of previously made configurations), and/or implicitly expressed (e.g., in the form of previous selections). In several embodiments, applications can estimate users' likely preferences even when no such preferences have been expressed by the user (e.g., based on observations of past user selections and preferences related to other actions, and/or based on observations of other users and their selections and preferences.

While specific systems and components for a secure sharing architecture are described above, any of a variety of systems and components can be utilized for a secure sharing architecture as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a secure sharing architecture the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

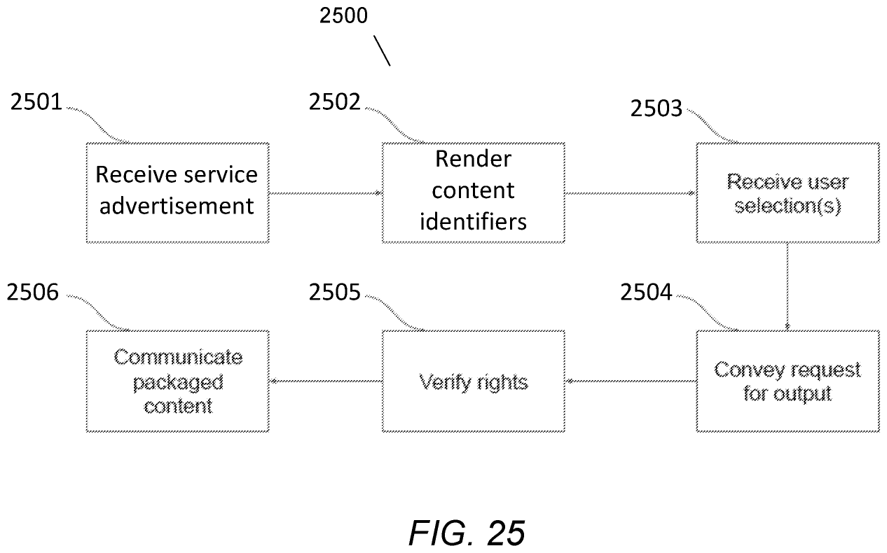

In some embodiments, content can be displayed in response to user inputs. An example process for displaying content in response to user inputs is conceptually illustrated in FIG. 25. In various embodiments, processes can be performed by a mobile device. a number of embodiments A process 2500 can receive (2501) a service advertisement. Service advertisements can include information about output units (e.g., output unit 2421) available for use for outputting and/or displaying content. In various embodiments, the service advertisement can be received by scanning a QR code, and/or in response to a request. The process 2500 can render (2502) a list of content identifiers corresponding to content that can be rendered on one or more output units (e.g., output unit 2421 of public device 2420). In several embodiments, content that cannot be output using available output units can be represented by grey and static icons. In many embodiments, content that can be output to available output units can be represented by colored and dynamic icons. Dynamic icons can correspond to sequences of images that replace each other over time. The process 2500 receives (2503) a user selection for one or more of the content elements that can be output. The process can convey (2504) a request to output the selected content elements (e.g., output request 2432). The process can verify (2505) rights corresponding to the rendering of the selected content elements. In several embodiments, verification can be performed by verifying certificates, CRLs, and/or interacting with a selected public device. Interacting with the selected public device can include performing a software-based attestation or other malware verification related to public device. The process 2500 can communicate (2506) packaged content to a selected output unit (e.g., output unit 2421). Packaged content can include content encrypted for the selected output unit, and/or authenticated using a key associated with a storage entity (e.g., storage entity 110). In several embodiments, packaged content transmitted to the selected output unit.

In several embodiments, users can display content associated with tokens (e.g., NFTs) on a TV in a hotel room. NFT can include image elements, audio elements and/or script elements. Script elements can include artificial intelligence (AI) code that improves the rendering of image elements by interpolating between two frames, thereby creating smoother transitions and better resolution than if no interpolation were performed. NFTs can include rendering requirements stating that image elements and audio elements can be rendered on output devices with associated certificates asserting security levels of output devices exceeding image and audio thresholds (e.g., 5 points out of 10, or another condition). In several embodiments, the rendering requirements can require that security levels exceed script element thresholds in order for script elements to be transmitted to and used on display units. In some embodiments, rendering requirements can include that the display unit is manufactured by a manufacturer on a whitelist included in the rendering requirements.

In many embodiments, users can select to share content with other users in a manner that does not expose the content to the wallet of the recipient user. In several embodiments, wallets of content owners cause content to be end-to-end encrypted for an output unit associated with the wallet of the content lender (e.g., content owner), with indications or instructions of how the content can be rendered. This approach can be beneficial where the output unit of the lender has a higher security rating than the wallet of the lender. This approach can limit the exposure of the content to other wallets. In many embodiments, wallets of lenders can store encrypted copies of content and forward the encrypted copies to output units associated with the lenders.

In various embodiments, a user that is the lender may not know the identity of the output unit to be used at the time of initiating the lending, in which case the content can be encrypted using a content delivery key (e.g., a symmetric key). Later, at the time of intended rendering, the wallet of the lender can identify the output unit selected for display and request that the content delivery key be conveyed to the output unit (e.g., encrypted using the public key of the output unit). This approach can enable borrowed content to be rendered multiple times using multiple output devices, when the owner wallet permits the display of the content by transmitting the content delivery key to the selected output unit, encrypted using this unit's public key. In several embodiments, certificates associated with public keys of output units can be used to determine security levels of associated output units. In some embodiments, certificates associated with public keys can be used to determined other classifications of output units (e.g., as described elsewhere herein).

In many embodiments, content owners can enable multiple simultaneous loans of content (e.g., associated with an NFT). In several embodiments, based on the policies associated with the content, up to a threshold number of output units can be allowed to render the content at a time. In several embodiments, multiple simultaneous loans of content can be controlled by the wallet of the content owner by having the wallets of display units check out content for a limited amount of time, such as 1.5 h, and the wallet of the owner can determine whether the maximum number of simultaneous output devices potentially using the content has been reached at any given time. In many embodiments, content delivery communicated to approved output devices can be associated with a duration during which the content can be rendered. In several embodiments, the output device can ensure that the content is rendered in compliance with any rules associated with the content. In certain embodiments, rules associated with the content can be communicated along with the encrypted content and/or with the encrypted content delivery key.

In a number of embodiments, content can be associated with charging policies. Charging policies can specify fees to be paid each time content is rendered. In some embodiments, policies can specify different costs for different actions. policies can specify different costs for display of content on an output unit associated with the content owner versus display of content on an output unit associated with other users. In many embodiments, charges can be paid to content originator, parties designated by content originators, or other parties with rights to the content. In several embodiments, payments can be split and fractions of payments can be provided to multiple parties. In many embodiments, content creators can transfer content to one or more users, which can be referred to as content owners. In many embodiments, content owners pay an amount to received content from content creators. In many embodiments, owners of content can be paid a first amount when the content is rendered by an output unit, and an originator of the content (e.g., an artist) can be paid another amount.

For example, a content creator can sell a first number (e.g., 100) of copies of an NFT to a second number (e.g., 100) different parties, which are content owners. The content owners can each make a first transaction (e.g., pay $10,000) to receive the content. The content owners can then act as lenders of the content. Each loan can be initiated after a lending fee is paid by a wallet owner of the received loaned content. For instance, the wallet owner can need to make a second transaction (e.g., pay $2) to initiate the loan, after which he or she can designate a qualified output unit to be used to render the content up to a third number (e.g., three) of times. A transaction (e.g., a payment of half of the $2) can be sent to a content owner and/or a content originator.

While specific processes for displaying content in response to user inputs are described above, any of a variety of processes can be utilized for displaying content in response to user inputs as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference displaying content in response to user inputs the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

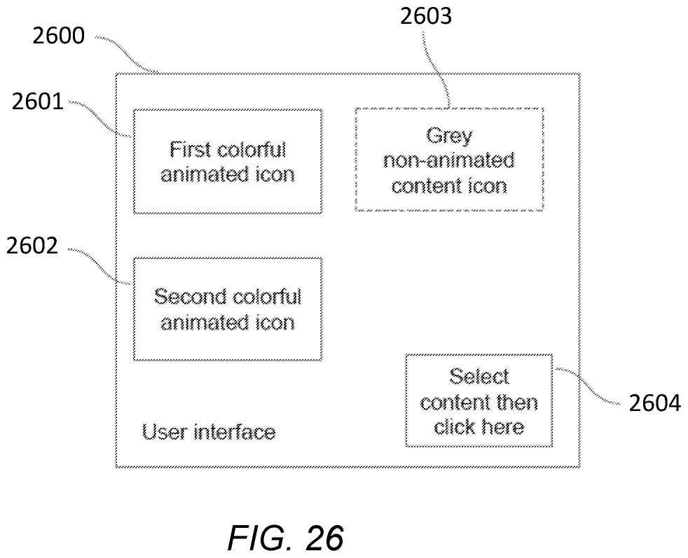

In several embodiments, wallets can have user interfaces. An example user interface associated with a wallet is conceptually illustrated in FIG. 26. The user interface 2600 is associated with a wallet (e.g., wallet 2402) of a device (e.g., mobile device 2401). The user interface 2600 can include a first colorful animated icon 2601. First colorful animated icons can correspond to first content elements. First content elements can be output on an output unit. The output unit can be an output unit that is determined to be in the presence of a mobile device. The user interface 2600 can include a second colorful animated icon 2602. Second colorful animated icons can correspond to second content elements. Second content elements can be output on an output unit. The output unit can be an output unit that is determined to be in the presence of a device. The user interface 2600 can include a non-animated and greyscale icon 2603. The greyscale icon can represent content element that cannot be output on detected output unit. The user interface 2600 can include a button 2604 that has instructions and is used for the user of user interface 2600 to request an output associated with one or more content elements whose icons (e.g., as the first colorful animated icon 2601) have been selected (e.g., by clicking on the first colorful animated icon 2601 and then on button 2604).

In some embodiments, users can use public output units by connecting to it using a personal device (e.g., a cell phone on which a wallet application is running). In several embodiments, the contents of a wallet can be located on a separate device and/or server, but the wallet access can be performed from an application on a cell phone. Storing a wallet, on a first storage, and accessing the wallet from an application can be referred to this as a wallet application with a remote storage facility. In many embodiments, wallets with remote storage facilities can be used to instruct remote storage facilities to packet content and send it to selected output units (e.g., over a secure channel). In several embodiments, remote storage facilities can have capabilities to perform processing, such as verifying the security posture of the selected output units based on certificates associated with it, based on certification revocation lists (CRLs), based on assessments made by security vendors, and/or based on the requirements associated with tokens holding content to be rendered or otherwise used on the output units. In a number of embodiments, using remote storage entities can enable desirable privacy features. In many embodiments, remote storage entities can act on behalf of the wallet and its associated device without identifiers (e.g., MAC addresses) having to be disclosed from the device to the output unit. The device including the wallet can passively listen in on service advertisements and select one or more output units based on such advertisements, then send a request to the remote storage facility instructing it to transmit selected content for rendering or other use at the selected output unit. In many embodiments, users can render content such as a movie, music, or a game on an output unit in a manner that protects the user's privacy. In several embodiments, output units can have TEEs, DRMs and/or other secure execution environments that can receive, process, and/or renders content. In many embodiments, output units can be associated with untrusted modems through which content is received and forwarded to output units. Content owners can verify (e.g., based on certificates and other assessments), that output units have satisfactory security postures, and would not have to make any assessment regarding the trustworthiness of the modem or any associated infotainment unit other than the output unit. In many embodiments, the user can be not trackable and/or not profileable by malicious or intrusive software entities associated with modems of output units. In many embodiments, malicious or intrusive software entities would not be able to know the nature of the content in a situation where it is not inserted on the path between the output unit and the screen/loudspeakers/etc., other than by the addition of eavesdropping modules tracking the analogue content in a post-rendering manner. Such abuse is less accurate and would still not make de-anonymization easy.

While specific systems and components for a user interface associated with a wallet are described above, any of a variety of systems and components can be utilized for a user interface associated with a wallet as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a user interface associated with a wallet the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

### Wallet Spam Detection and Protection Method

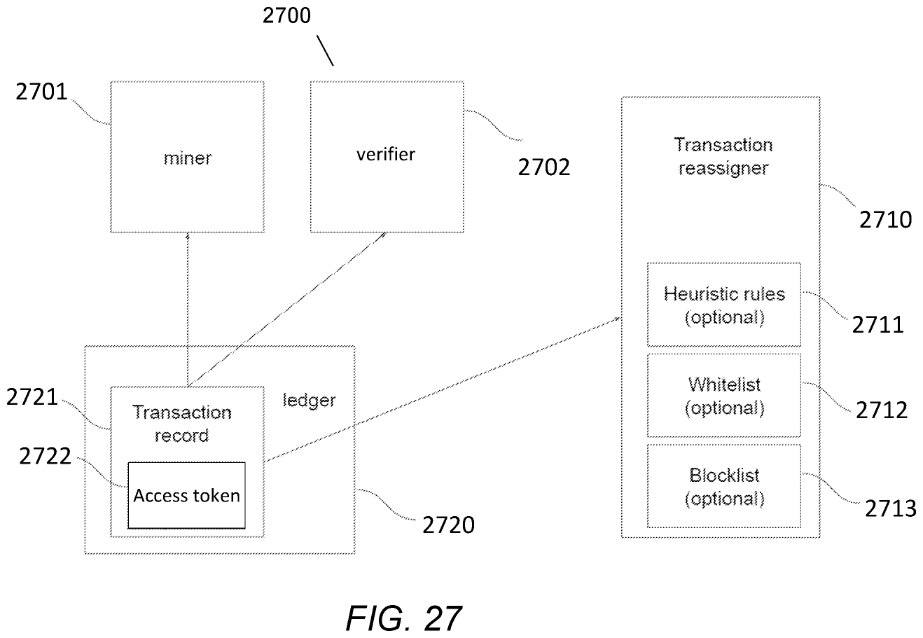

In various embodiments, tentative transactions can be subject to review. An example of a system for the review of a tentative transaction is conceptually illustrated in FIG. 27. A system 2700 can include a ledger 2720, a miner 2701, a verifier 2702 and/or a transaction reassigner 2710. The ledger 2720 can include a transaction record 2721. The Transaction record 2721 can include an access token 2722. Access tokens can indicate that the indicated recipient associated with the transaction record is willing to receive the transaction. Miners can verify access tokens and only include in the collection of selected transactions to be timestamped those transaction records with valid access tokens (e.g., transaction record 2721 with a valid access token 2722). Verifiers (e.g., validator) can perform the same verification when performing for operation of a cryptographic system (e.g., when performing a consensus mechanism). Transaction reassigners can assess transaction records to perform at least one verification among a collection of potential verifications. For example, a first verification can evaluate the presence of a valid access token 2722 in the transaction record 2721. A second verification can use one or more heuristic rules 2711. A third verification can use a whitelist 2712. A fourth verification can use a block list 2713.

In some embodiments, multiple verifications can be performed by the transaction reassigners. When transaction reassigners determine that transactions associated with a transaction record should be blocked, transaction reassigners can automatically reassign ownership of the transaction of transaction record. Automatically reassigning ownership of the transaction can include transferring the associated token to a receiving party. In certain embodiments, the receiving party can have a public key with no corresponding secret key, causing the token to be destroyed. Transaction reassigners can also perform filtering classifications. Filtering classifications can associate transactions with spam categorizations (e.g., tag, and/or folder) of the recipient.

In several embodiments, wallets can control the adding of tokens to the wallets. Wallets in accordance with a variety of embodiments of the invention can be associated with a public key and one or more access tokens. In several embodiments, validity of access tokens can be verified publicly. In various embodiments, to transfer ownership of a token (e.g., an NFT and/or a crypto payment) to a wallet associated with a given user, a valid access token needs to be associated in the ownership transfer record. When access tokens are not valid or are not present, an action can be taken. The actions can be preset, and can include (but are not limited to) automatically declining transfers, filtering actions, etc. Actions can be determined by wallets to which transfers are made.

Actions can include filtering actions. Various filtering actions can be performed. A filtering action can be selected based on the characteristics of a token that was transferred to the wallet. Characteristics can include, token type, token content, and/or whether the token and/or associated information match any additional criteria (e.g., contain keywords that have been used for filtering. Filtering actions can depend on the identities of entities (e.g., entities associated with public keys) from which tokens were transferred, Filtering action can depend on information related to the identity (e.g., filtering actions can depend on whether this is a user on a whitelist stored by the wallet, whether this is a user in a blacklist stored by the wallet, whether this is a user with which the user has recently communicated, whether this is a user from or too which the wallet has previously engaged in a token transfer, any prior filtering actions taken for transfers from this sender, and/or other more). In many embodiments, filtering actions can be fully automated, and/or can depend on inputs from users associated with wallets to which tokens are transferred. In many embodiments, a filtering action can be selected based on the filtering action of other wallets that can be associated with the token receiving wallets. Associated wallets can be referred to as friend wallets. In various embodiments, filtering action can be based on friend wallets having declined transfers from the same sender, and/or a transfer of the same and/or related content. In various embodiments, filtering actions include rejecting the transfer (e.g., by automatically transferring the token back to the previous owner); destroying the token (e.g., by transferring it to a wallet identified with a public key to which it is understood that there is no corresponding private key), and/or placing the token in a spam folder compartment (e.g., partition) of the receiving wallet. In many embodiments, spam folder compartments can allow wallet users to inspect received tokens, to execute content related to the token in a sandbox, and/or to make determinations based on the result of the execution.

In many embodiments, access tokens are one-time-use credentials. In some embodiments a one-time use credential can be a digital signature D on the transferred token T. In many embodiments, a digital signature on the transferred token (D,T) can be publicly verified using a public key Y. Public databases, which can use blockchains (e.g., distributed ledgers), can store all one-time-use credentials and their associated public keys. In various embodiments, to determine whether a one-time-use credential is valid, a verifier can determine whether another signature D2 has previously been recorded for the same public key Y. In several embodiments, when the verifier determines that another signature has not previously been recorded for the same public key and D is a valid digital signature on T, then D is a valid one-time-use token, and T is a valid transfer. Then (D,Y) is recorded on the blockchain. In certain embodiments, if the same public key Y has been used in the past, as determined by a record (D2, Y) on the blockchain, then D is not considered valid. This same technique can be used to create limited-use access tokens. Limited-use access tokens can be tokens that can be used for up to a number of transfers to a given wallet or collection of wallets associated with the same creator of access tokens. In several embodiments, policies can be associated with the wallet for which an access token governs transfer rights. Policies can determine how many transfers a given public key Y and its associated digital signatures can be used for.

In many embodiments, access tokens can be generated (at least in part) by processes associated with wallets to which transfers are enabled by the access tokens. In several embodiments, access tokens can be digital signatures that are verified using recipient wallet public keys. Digital signatures can be generated using the associated recipient wallet private keys. Digital signatures can specify sets of tokens that are allowed to be transferred. Digital signatures can sign at least a portion of the allowed tokens and/or references to it. In many embodiments, access tokens can specify a time period (e.g., 10 minutes from being issued) for which it is valid. Access tokens can specify parties that are allowed to transfer to a recipient wallet specified by the access token. Access tokens can specify a combination of constraints. In a number of embodiments, a signature can apply to one transfer or to larger number of transfers. In several embodiments, a digital signature that is part of an access token can reference conditions of transfers (e.g., how many transfers, what type of tokens can be transferred, and/or the duration during which the tokens can be transferred). In some embodiments, access tokens can refer to an entity that is allowed to initiate the transfer (e.g., using a public key that is associated with the sending wallet).

In various embodiments, filtering of tokens transferred to wallets can be performed by processes that are part of and/or associated with the wallets. In various embodiments, as a user opens his or her wallet, the wallet can determine what tokens have been transferred to it. The wallet can determine, which tokens, if any, have valid access tokens associated with them. In several embodiments, for transfers without valid access tokens, the wallet can determine, using policies associated with the wallet, whether one or more of these transfers should be accepted to the wallet. In several embodiments, the wallet can assess various transfers (e.g., transfers remaining after other filtering steps) using heuristic rules. In several embodiments, heuristic rules can be generated by a machine learning (ML) component that is part of the wallet (e.g., an ML component of the wallet which has been trained on previous user actions and wallet configurations). In some embodiments, heuristic rules can be provided by one or more token-spam classification service providers. Token-spam classification service provider heuristic rules can be provided as part of a subscription or membership by the wallet, and/or by an entity associated with the wallet (e.g., such as an employer of a user who is associated with the wallet in an ownership capacity).

In many embodiments, access tokens can be verified by performing lookups to databases (e.g., blockchain-based database, distributed ledgers). An access token can include a digital signature created by the entity that originates an ownership transfer associated with a token. The digital signature created by the originating entity can be verified without the need to perform a lookup (e.g., based on the origination transaction). In some embodiments, both a digital signature-based verification and a lookup is performed to verify an access token.

In many embodiments, at least a portion of a verification of an access token can be performed using a consensus mechanism as an ownership transfer transaction is recorded. In some embodiments, a miner and all verifiers can verify that an access token includes a legitimate digital signature, and/or collections of digital signatures. In many embodiments, verification of digital signatures can be performed before recording a given ownership transfer transaction on the blockchain. In a number of embodiments, a wallet that corresponds to a receiver of a token can perform a portion of the verification of the access token. In several embodiments, access tokens can relate to types of content being transferred. In many embodiments, validity of access tokens can depend on verifying that the transferred content matches the pre-set type associated with the access tokens. In many embodiments, content can be encrypted so that only the intended recipient can decrypt it. In several embodiments, types associated with access tokens and/or types of content associated with tokens can include video content, audio content, images, text, executable code, and/or other content types.

In many embodiments, tokens can be filtered (at least partially) by a third-party service provider associated with the wallet indicated as a recipient of one or more transfers. In various embodiments, third-party service providers can monitor token transfers. Third-party service providers can identify when transfers are performed to an address that they protect. In several embodiments, when a transfer is detected, a third-party service provider can determine whether the transfer is valid. In various embodiments, validity can be determined based on the validity of an access token, information related to the sender identity relative to an access control list (ACL) provided by the wallet of the indicated recipient, the content of the token, a combination of these and/or other verification methods. In several embodiments, verification of content relates to whether the content matches one or more blocklists. In some embodiments, entries on blocklists can be selected by wallet owners, recipients indicated by transfers, and/or others which can be associated with the third-party service provider or the jurisdiction of the recipient wallets. In many embodiments, verification includes whether the content matches a whitelist associated with the indicated recipient wallet (e.g., is a payment), includes a form that is used to place an order, and/or includes an offer from an entity whitelisted by the recipient wallet. In a number of embodiments, third-party service providers can provide filtering information to protected wallets. Protected wallets can perform sorting actions on incoming tokens based on filtering information. Sorting actions can include (but are not limited to) blocking, placing in priority queues, placing in portions of the wallet used for incoming orders, and/or placing in a spam folder compartment of the recipient wallet, etc.

In several embodiments, third-party service providers can perform at least some sorting actions with wallet permission. Third-party service providers can have a key (e.g., a private key) that enables the blocking of content that does not have a valid access token. The key can be associated with a smart contract that determines whether the key can be used for a particular usage scenario. When the key can be used for a usage scenario, a smart contract can output an agreement. When the key cannot be used for a usage scenario, a smart contract can output a rejection. In certain embodiments, the output of the smart contract associated with the key can be used to selectively control the outsourcing of control by a wallet to third-party service providers. In several embodiments, the smart contract can specify the conditions under which the key can be used. Specifying the conditions under which the key can be used makes it not possible for a corrupt third-party service provider to perform undesirable actions. An example undesirable action can include reassigning payments for the recipient wallet to an accomplice account of the third-party service provider, which amounts to theft. Performance of undesirable actions by the service provider can be prevented by using the output of the smart contract to validate the transfer, (e.g., rendering it legitimate or not). In various embodiments, this determination of legitimacy can be determined by any verifier, and/or by recipient wallets. In several embodiments, determining legitimacy includes evaluating the smart contract on its input, e.g., the token being transferred. Selective outsourcing of sensitive capabilities can be used for other purposes, beyond filtering of token transfers, and is a powerful tool to facilitate the delegation of processing in distributed scenarios.

In several embodiments, smart contracts can limit actions of third-party service providers in ways specified by policies. Policies can be referenced by smart contracts. In some embodiments, one rule associated with a policy can be that the third-party service provider may not block or cause transfers out from the wallet of any token that corresponds to crypto funds (e.g., a token indicating some amount of crypto currency). In various embodiments, policies can specify that third-party service providers can only perform actions related to transfers in to the wallet within a specified time period from the occurrence of the transfer (e.g., such as for ten minutes after the transfer took place). In a number of embodiments, rules can specify that third-party service providers can only perform actions on transfers that do not include valid access tokens. In some embodiments, by configuring the rules associated with the smart contract governing the capabilities associated with the key provided to the third-party service provider, the wallet can selectively delegate some capabilities, but not others. In many embodiments, wallets can perform any legitimate transactions on wallet contents, (e.g., using a second private key that is not delegated). In various embodiments, wallets can be associated with multiple private keys where one or more of these can be delegated to different third-party service providers. In several embodiments, a sufficient number of private keys must be known to perform some actions (e.g., filtering actions). In some embodiments, reassigners can be third-party service providers and/or wallets. In various embodiments, wallets can take on functions associated with third-party service providers. Third-party service providers can be miner and/or verifiers.

While specific systems and components for a system for the review of a tentative transaction are described above, any of a variety of systems and components can be utilized for a system for the review of a tentative transaction as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a system for the review of a tentative transaction the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

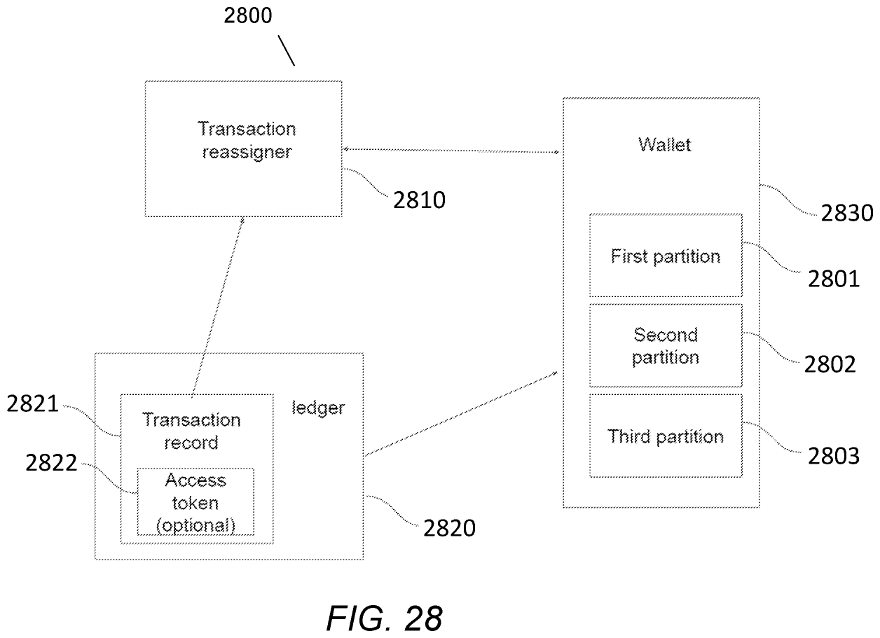

In many embodiments, classification information can be conveyed to wallets associated with transaction records being classified (e.g., associated with the recipient, and/or the sender). An example of a system for the conveyance of transaction record classification is conceptually illustrated in FIG. 28. The system 2800 can include a transaction reassigner 2810, a ledger 2820, and a wallet 2830. The ledger 2820 can include a transaction record 2821. The transaction reassigner 2810 can access the transaction record 2821. The wallet 2830 can include a first partition 2801, a second partition 2802, and a third partition 2803. Based on transaction records, transaction reassigners can make determinations, as described in relation to FIG. 27, of one or more classifications associated with the transaction records. In several embodiments, classifications can be informed by multiple transaction records being accessed by transaction reassigner. In many embodiments, transaction reassigners can indicate wallets (e.g., wallet 2830) to which transactions should be assigned. In various embodiments, tokens corresponding to transaction records (e.g., transaction record 2821) can be placed in one or more partitions of wallets (e.g., into first partition 2801, into second partition 2802, and/or into third partition 2803). In various embodiments a first partition (e.g., first partition 2801) can correspond to tokens that transaction reassigner (e.g., transaction reassigner 2810) determines, based on one or more rules, would be desirable to the owner of wallet (e.g., wallet 2830). In certain embodiments, tokens can be transferred from a trusted entity. In several embodiments, a second partition (e.g., second partition 2802) can correspond to a spam folder of a wallet (e.g., wallet 2800). The spam folder can include tokens that may not be desirable to the owner of wallet. In several embodiments, a third partition (e.g., third partition 2803) can correspond to commercial content, such as promotional offers. In certain embodiments, various numbers (e.g., 1, 2, 3, 4, and/or other numbers) of partitions can be included in a wallet. Different partitions can correspond to different priorities of tokens, different types of tokens, different values of tokens, etc. In several embodiments, tokens can be accessed by wallets. Wallets can access transaction records including references to the content associated with tokens. In several embodiments, a transaction reassigner can be a part of a wallet, can be a service provided by miners and/or verifiers, and/or can be provided by an external service provider that the wallet is connected to (e.g., over the Internet).

In many embodiments, undesirable tokens can be placed in a trash folder. Tokens that may be likely not desirable, based on heuristic rules, can be placed in a spam folder. These folders can be part of a wallet. However, a wallet does not need to store the tokens, or content associated with them. A wallet can store a reference to the token and/or a classification that indicates one or more partitions of the wallet that the token is associated with. When a user reviews the spam folder, he can move tokens in the spam folder to a trash folder.

In several embodiments, various tokens can also be moved between partitions. Methods for moving various tokens between partitions are disclosed co-pending U.S. Provisional Patent Application No. 63/280,184 filed Nov. 17, 2021 titled “Wallet User Interface for Management of Interaction” by Markus Jakobsson, the disclosure of which is incorporated herein by reference in its entirety. In many embodiments, users can empty the trash folder. In various embodiments, emptying the trash folder includes reassigning all the tokens of the trash folder to a non-existent entity. co-pending U.S. Provisional Patent Application No. 63/277,472 filed Nov. 9, 2021 titled “Green Proof of Stake” by Markus Jakobsson, the disclosure of which is incorporated herein by reference in its entirety. To save gas fees, reassignment can be performed in batches, e.g., thousands of NFTs that can be assigned at the same time to the same (non-existent) entity in one transaction. In several embodiments, reassignment can be performed the wallet, or by an intermediary with an access token allowing the reassignments of NFTs on behalf of the owner of the wallet. In certain embodiments, the rights for intermediaries to reassign tokens (e.g., NFTs) can be conveyed by the wallet generating a digital signature on the token(s) to be reassigned. The rights can include an indication of how the tokens should be reassigned. In several embodiments, this information can be transmitted to the entity in charge of the reassignment. In various embodiments, tokens can be reassigned to a non-existent entity or to an entity that exists. The entity in charge of reassignment can be the reassigner described in FIGS. 1 and 2. In many embodiments, any token in the trash folder can be erased from being viewed in the wallet by having any reference removed from the wallet. However, such tokens can still be associated with the wallet, and just not accessible by the user of the wallet. In several embodiments, the trash folder of a wallet can be an archive including elements that can be not desirable to the user. Such an archive can be destroyed by the user by reassigning the contents (e.g., as described above).

While specific systems and components for a system for the conveyance of transaction record classification are described above, any of a variety of systems and components can be utilized for a system for the review of a system for the conveyance of transaction record classification as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a system for the conveyance of transaction record classification the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

### User Interface for Conveyance of Terms

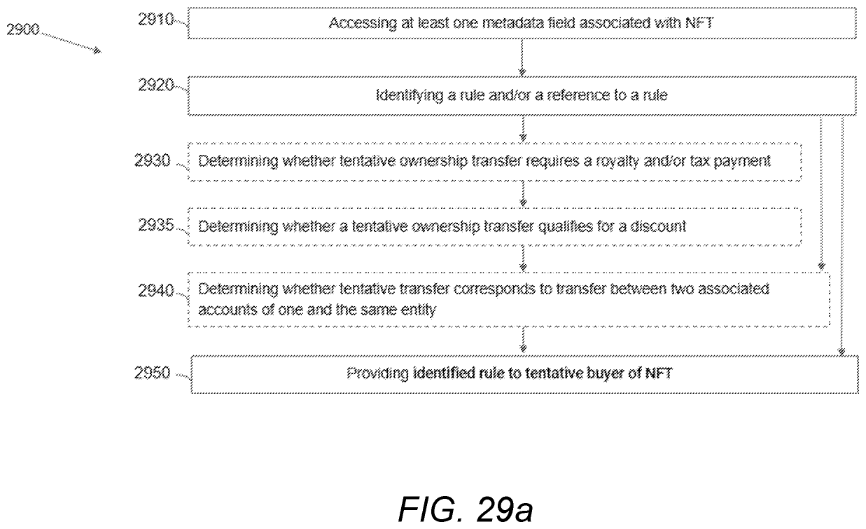

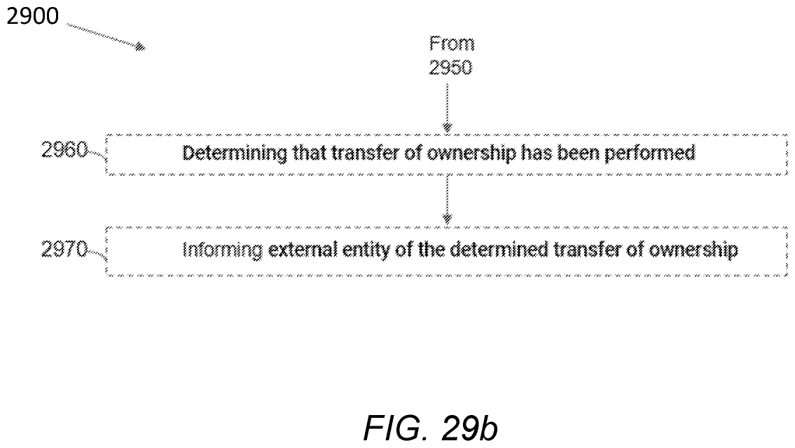

In several embodiments, processes can be used to enforce rules associated with NFTs. An example flowchart of a process for enabling the enforcement of rules associated with an NFT is conceptually illustrated in FIG. 29a-b. A process 2900 can access (2910) at least one metadata field associated with the NFT. In several embodiments, NFTs can be associated with one or more metadata fields. In various embodiments, a metadata field can include a rule and/or a reference (e.g., a URL). The process 2900 can identify (2920) a rule and/or a reference to a rule.

The process 2900 can include determining (2930) whether a tentative ownership transfer requires a royalty payment or payment of a sales tax. In several embodiments, the identified rule described above can pertain payments (e.g., the identified rule can pertain to payment of tax and/or royalty upon transfer of ownership of the NFT) as described herein. The process 2900 can also include determining (2935) whether a tentative ownership transfer qualifies for a discount on fees (e.g., royalty fees, and/or taxes). In several embodiments, there can be certain situations in which no payment of fees or taxes are required or that a fee, such as tax or royalty, may be associated with a discount for a particular transfer.

The process 2900 can include determining (2940) whether a tentative transfer corresponds to a transfer between two associated accounts of one and the same entity. In several embodiments, a process may further determine how the rule related to a transfer between associated accounts belonging to the same entity. In some embodiments, when an owner transfers an NFT between two wallets both belonging to the owner, the transfer may generally not be subject to any payment of fees.

The process 2900 can provide (2950) the identified rule to a tentative buyer of the NFT. In various embodiments, rules are provided to tentative buyers by a user interface as described elsewhere herein.

In several embodiments, processes for enforcing rules associated with NFTs can include informing external entities of ownership transfers. A process 2900 can include determining (2960) that a transfer of ownership has been performed. The process 2900 can include informing (2970) an external entity of the determined transfer of ownership. In several embodiments, once a transfer of ownership is performed, then the rule or rules may demand one or more actions to take place. The actions can include paying a royalty, paying a tax fee and/or any other contractual obligation defined by the one or more rules. In many embodiments, in order to ascertain that fees are paid and/or obligations are fulfilled, processes can include informing external entities of transfers of ownership of NFTs. In a number of embodiments, external entities can be admin entities, parent accounts (e.g., parent accounts associated with children's wallets and/or marketplace accounts), law enforcement official accounts (e.g., for overseeing the actions of convicts and/or former convicts), tax office accounts, and/or user accounts to which royalty payments are due, etc.

While specific processes for enabling the enforcement of rules associated with an NFT and the same including informing external entities of ownership transfers are described above, any of a variety of processes can be utilized for enabling the enforcement of rules associated with an NFT and the same including informing external entities of ownership transfers as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to enabling the enforcement of rules associated with an NFT and the same including informing external entities of ownership transfers the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

In some embodiments, processes can access at least one metadata field associated with an NFT, extract terms, parse the contents and/or identify a rule and/or a reference (e.g., a URL) indicating a rule. In a number of embodiments rules can indicate an amount, and other information related to a transaction (e.g., a royalty payment) associated with transfer of ownership of the NFT. In various embodiments, a module can determine whether a tentative ownership transfer requires a royalty payment and/or a sales tax. In several embodiments, a module can determine whether a tentative ownership transfer qualifies for a discount on fees. Module determinations can be based on classifications associated with the user. A classification can include a jurisdiction or a membership. In some embodiments, a module can be associated with a marketplace, a wallet application and/or a browser. In various embodiments, modules can be implemented as software in marketplaces, wallet applications and/or browsers. The determining module can be referred to as a terms extractor module. In various embodiments, at least one metadata field can communicate contractual terms related to holders permitted uses of assets. In several embodiments, a holder can be granted one of many possible license terms. Possible license terms can include (but are not limited to) private use/non-commercial exploitation, personal public display/non-commercial exploitation, public display/non-commercial exploitation, and/or reproduction/commercial exploitation.

In many embodiments, enforcement mechanisms can be used with required payments, such as sales taxes. In several embodiments, enforcement mechanisms can be used as a restriction mechanism to prevent transfers of NFTs to entities meeting a condition. In some embodiments, a condition could include citizens resident in a jurisdiction in which, for whatever reason, ownership of the NFT is prohibited. Prohibition of an NFT can be due to a general ban on owning digital assets, and/or due to a specific ban related to the NFT in question due to the content that it references.

In several embodiments, processes can determine whether a tentative transfer corresponds to a transfer between two associated accounts of one and the same entity. Determining that a transfer between two associated accounts of one and the same entity can indicate that no royalty payment is due. Transfers of this type often occur when an NFT holder moves an asset from a hot-wallet to a cold-wallet. In many embodiments, a module can determine a relationship between two wallets. The relationship between the wallets can at least partially determine fees (e.g., royalty fees and/or taxes) associated with transfers between the wallets. A relationship between accounts can be that the accounts of one and the same entity. In various embodiments, modules can access the metadata field and/or identify an association between two wallet addresses. In several embodiments, the metadata field can be the metadata field of a token to be acted (e.g., transferred, and/or accessed) upon. For instance, a wallet address can be associated with the owner prior to the tentative ownership transfer (e.g., a seller) and a wallet address of a recipient of the NFT (e.g., a buyer). Determining a relationship between two wallet addresses can be performed independently of a purchase amount. In several embodiments, determinations that two addresses can be associated can be publicly verified. Public verification of association between two addresses is disclosed in co-pending U.S. Provisional Patent Application No. 63/322,265 filed Mar. 22, 2022 titled “Escrowed Wallet and Transaction Tracking Technology” by Markus Jakobsson.

In many embodiments, sales tax can be levied on a user belonging to a specified jurisdiction. Methods wherein escrowed information can indicate a jurisdiction, and payment of local taxes such as sales taxes or income taxes can be determined based on stated jurisdictions are disclosed in co-pending U.S. Provisional Patent Application No. 63/322,265 filed Mar. 22, 2022 titled “Escrowed Wallet and Transaction Tracking Technology” by Markus Jakobsson. In contexts where no jurisdictional information is available, a fixed amount (e.g., corresponding to a maximum fixed rate) can be required to be paid (e.g., to an entity managing security and/or royalty payments). In some embodiments, users are encouraged to register their jurisdiction in order to lower their fees (e.g., lower their fees to less than the maximum fee rate). In various embodiments, jurisdictions can be registered in a manner that is not disclosed, but which could still be verified in cases of suspicion of incorrect or insufficient payments. In several embodiments, jurisdictions can be registered and verified using zero-knowledge proofs.

In various embodiments, a marketplace can require all transactions be made subject to its terms of service by referring to them during the check-out process or otherwise bringing their existence and applicability to the affirmative attention and acceptance of the purchaser. The terms of service can further include terms of service relating to events, such as rentals, the rendering of content, the initiation of evolution, and more.

In several embodiments, marketplaces can present terms of service and policies to users prior to a transaction. In several embodiments, processes can enable the making of notifications and/or user agreement to terms a necessity for the performance of an action. In various embodiments, the action can be a sale, a use, a and/or content transformation. In various embodiments, actions can be conditional based on acceptance of notifications and/or agreement to terms. Conditional actions can be facilitated by enabling the running of scripts associated with and/or performing actions required by the terms, policies and/or royalty requirements. In many embodiments, scripts can be included in, referenced by, and/or activated by data included in meta-data fields. A person of skill in the art will recognize that these approaches can be combined, as can variations of these, of which there can be many. The use of one or more of these approaches, whether independently or in combination, as well as of versions of these, enables litigation of and enforcement of terms, where terms can be royalty terms in accordance with many embodiments of the invention.

In several embodiments, user interface components can receive information processed by terms extractor modules. In some embodiments, processes can determine a presentation format suitable for an interface used by a user, and/or can convey information according to the determined presentation format to the user. Conveyed information can be in the form of a notification of a requirement, a warning of a legal risk, an interactive interface enabling a user to select what payments to make, an interface requesting additional information from the user (e.g., the user's jurisdiction, and/or applicable tax requirements), and/or a notification of the terms of use of an asset. In various embodiments, notifications can indicate whether some funds will be automatically held if no action is taken by the user, and/or can indicate how the user can challenge such a decision. In various embodiments, notifications can indicate limitations placed on the NFT until an action is taken. In some embodiments, the action can correspond to a payment associated with the extracted rules and/or with the provision of information by the user. Provisions of information by users can include registration of the appropriate jurisdictional information and/or associated evidence. Registration can be automatically processed by a registration module.

In several embodiments, information included or referenced in metadata fields can be determined based on one or more configuration values. In some embodiments, the disclosure of some types of data can be required in some jurisdictions. The requirement can be expressed in a first configuration value that is associated with jurisdictions. In various embodiments, users in some jurisdictions, may have no disclosure requirement, such users can set their own preferences regarding whether to having various disclosure information displayed. In many embodiments, determining what to display (e.g., to users) can be based on a security assessment. In various embodiments, security assessments can be performed by wallets, and/or users. In some embodiments, users can approve transactions that involve anomalous amounts of funds to be paid (e.g., anomalous relative to the rights associated with the asset to be transacted), and/or can be notified of these rights and of the payment amount. In a number of embodiments, determinations of what information to render can depend on local and personal configurations as well as contextual information.

In several embodiment information can be presented as a notification, an interactive popup, and/or in other ways. Information can be presented in response to user actions (e.g., mouse-over an image associated with the NFT, a click on a button indicating an interest to purchase, and/or a drag-and-drop action being associated with a request to perform an action). Information being presented in response to user actions is disclosed in co-pending U.S. Provisional Patent Application No. 63/280,184 filed Nov. 17, 2021 titled “Wallet User Interface for Management of Interaction” by Markus Jakobsson.

In various embodiments, users can determine that rules do not apply to them in particular contexts. In some embodiments, making a gift of an NFT can be subject to a different set of rules then selling an NFT. For example, a context where Bob wishes to gift an NFT to his niece Cindy. In an example, Bob gifting an NFT to Cindy can be a situation that is exempt from royalties. However, Bob's wallet may not know a priori that Cindy is not a stranger to whom Bob attempts to perform a trade for which Bob wishes to receive no cash payment in connection with the electronic transfer of ownership rights. In this example situation, Bob can indicate in an interactive interface that the recipient, Cindy, is receiving the NFT as a gift. This information can be recorded and analyzed. When Bob performs an anomalous number of such transfers, or the recipients can be not determined to be associated with Bob, then a corrective action can be taken. In the example, Cindy could be any gift receiver, and Bob could be any sender.

In several embodiments, two or more wallets can be registered as associated with each other. In a number of embodiments, association can be performed by storing a record in a database (e.g., a distributed ledger). In certain embodiments, at least a portion of a record can include a statement signed by one or both of the wallet private keys. In some embodiments, users having two wallets can associate these wallets with each other by creating such an association between the two wallets. Association of wallets can be publicly verifiable, and/or verifiable by designated entities. Designated entities can be selected based on characteristics associated with the user with the two wallets. For instance, the designated entity can be determined based on a user jurisdiction. In certain embodiments, the statement can indicate a relationship between the two (or more) wallets. Relationships between wallets can include (but are not limited to) that the wallets correspond to the same owner, that the wallets have overlapping owners, that the owners have some human relationship and/or other relationships. In a number of embodiments, evaluation of a signed statement can modify the calculation of fees (e.g., for transfer of ownership, the sharing of content, the sharing of access rights, etc.). This method serves to distinguishing a rental of an NFT from a no-fee lending of an NFT. A wallet with an anomalously large number of associations can be investigated (e.g., using fraud-detection methods, and can be flagged for escalated manual scrutiny). Investigations can be to determine whether proper royalties, rental fees, state taxes, income taxes, etc., are be being paid.

In many embodiments, wallets and/or accounts of marketplaces can be configured to extract metadata. In several embodiments, wallets and/or accounts can perform actions based on metadata, on configurations specified by users, and/or on configurations set by administrators and/or representatives of jurisdictions. In some embodiments, actions can include requiring users renting a particular type of NFT to agree to terms associated with the NFT. Terms can include not showing the content associated with the NFT in public, not attempting to reproduce the content associated with the NFT, not generating any derivative work based on the content of the NFT, etc. In many embodiments, administrators can be associated with content creators. Content creators can be associated with NFTs. Associating administrators to content creators and/or associating content creators with NFTs can be performed, by a marketplace, by a system providing content access to employees by providing wallets and/or NFTs, and other systems. etc. In many embodiments, users can be wallet operators, entities authorized to access marketplace accounts, and/or entities designated by authorized entities to perform actions associated with wallets and/or accounts. In several embodiments, accounts can be associated with access rights to one or more NFTs and their associated content. Access can be limited (e.g., not include the right to make changes to ownership, and/or other limitations) or it can be full access. In many embodiments, access can include enabling others to access NFTs and content associated with these. Access rights can also apply to fungible tokens such as crypto coins.

In a number of embodiments, extracted terms can be processed. In response to processing of extracted terms, messages can be sent to external entities. External entities can be entities external to the device where the processing is performed. Messages can indicate the results of the processing. In various embodiments an external entity is an enterprise admin, a parent account associated with a child's wallet and/or marketplace account, and/or a law enforcement official overseeing the actions of a convict or former convict. In many embodiments, notifications can identify the type of content accessed and/or the type and/or magnitude of actions performed. A magnitude of an action can correspond to a sale price of a token (e.g., an NFT). In some embodiments, the results of the processing can be logged (e.g., to allow a time-series analysis of the actions of one or more users).

In many embodiments, terms of service (ToS) associated with a resource (e.g., content associated with an NFT), can be indicated in metadata of the NFT. In various embodiments, the ToS can be indicated in the metadata by including a ToS description, a cryptographic hash of a ToS description, a reference to a location where a ToS description is stored (e.g., a blockchain), and/or a combination of such. In a number of embodiments, ToS descriptions can identify how many times a user renting an NFT can play content, what resolution content can be played on for a given NFT that a user is borrowing from another user, and/or whether an NFT can be played on a given type of rendering device (e.g., a projector used in a movie theater). In certain embodiments, the ToS can identify costs of using content, whether an NFT can be lent out or rented out, and/or whether an NFT can be bundled with other NFTs, and more. Bundling of NFTs is disclosed in U.S. Provisional Patent Application No. 63/365,269 filed May 24, 2022 titled “Directed Acyclic Token Structure”.

In certain embodiments, ToS descriptions can become associated with NFTs by generating meta-tokens that reference both ToS descriptions and NFT to be associated with the ToS descriptions. Generating and associating meta-tokens is disclosed in U.S. Provisional Patent Application No. 63/365,269 filed May 24, 2022 titled “Directed Acyclic Token Structure”. Other methods of associating data with each other is disclosed in U.S. Provisional Patent Application No. 63/213,251 filed Jun. 22, 2021 titled “Token Creation and Management Structure” and co-pending U.S. patent application Ser. No. 17/808,264 filed Jun. 22, 2022 titled “Systems and Methods for Token Creation and Management” by Markus Jakobsson and Stephen C. Gerber. In various embodiments, techniques for associating ToS content with tokens, can also be used to associate other types of data with the one or more tokens, as will be appreciated by a person of skill in the art.

In many embodiments, wallets can determine that ToS descriptions are associated with resources (e.g., NFTs and/or content elements NFTs). ToS descriptions can require that users associated with the wallet to which the NFT belongs, and/or of a display device used to render associated content of the NFT, must approve the ToS. ToS can be approved by clicking through a statement in which the ToS can be displayed or otherwise conveyed, and the user is provided with options including approving the ToS and rejecting the ToS. In several embodiments, the rendering of content, and/or other actions related to the NFT, can be conditional on the user's selection of response. Users can be asked to approve/reject ToS each time he or she initiates access to a given content element associated with a ToS. In some embodiments, responses can be stored and reused. In some embodiments, users who approve some ToS can cause the storing of this approval associated with the NFT. Approvals can be conditional on the transfer of ownership rights (e.g., on the use of content), and/or on performing an action. The action can be performed on and/or be related to the NFT. In several embodiments, actions can be the initiation of evolution. Token evolution and/or its initiation are disclosed in co-pending U.S. Provisional Patent Application No. 63/248,570 filed Sep. 27, 2021 titled “Content Evolution Techniques” by Markus Jakobsson. Terms of service responses can be policies implemented by NFT creators for spawned or peeling NFTs. Terms of service responses implemented by NFT creators for spawned or peeling NFTs are disclosed in co-pending U.S. Provisional Patent Application No. 63/275,713 filed Nov. 4, 2021 titled “User-Specific Evolution, Spawning and Peeling” by Markus Jakobsson and Perry R. Cook.

In several embodiments, user selections can conditionally cause initiations of communications of and/or logging of the user selections. In some embodiments, when a user approves a ToS for a given NFT, the approval can be stored in a log associated with the user (e.g., with the user's wallet and/or display device). The log can be a secure log. In number of embodiments, secure logs can be managed by a trusted execution environment (TEE). Secure logs can avoid user manipulation of log entries. In many embodiments, protection of log entries can be achieved using other techniques. Techniques for protection of log entries are disclosed in the 2009 publication “Server-Side Detection of Malware Infection” by Markus Jakobsson and Ari Juels, wherein a malware-resistant audit mechanism is disclosed. Techniques useful for the creation of secure logs are disclosed in co-pending U.S. Provisional Patent Application No. 63/362,880 filed Apr. 12, 2022 titled “Instant NFTs and Protection Structure” by Madhu Vijayan, Markus Jakobsson, Keir Finlow-Bates, and Stephen C. Gerber.

In many embodiments, ToS can be made available on public websites. Addresses associated with ToS can be conveyed in the ToS descriptor component of NFTs (e.g., in NFT meta-data). In several embodiments, ToS information can be stored in and/or associated with NFTs is various ways, as will be understood by a person of skill in the art. In several embodiments, a hash of a ToS can be associated with or stored in NFTs. In various embodiments, ToS can be stored in an InterPlanetary File Server (IPFS).

In some embodiments, ToS can have human-readable components (e.g., including HTML with text and images), and machine-readable components (e.g., which can be in the form of XML or a machine-readable smart contract). ToS can also include certifications (e.g., digital signatures on the human-readable and machine-readable components). In several embodiments, certifications can attest to the mapping between human-readable and machine-readable components. In many embodiments, human-readable components of ToS can be rendered on devices (e.g., display devices). Rendering on devices can include playing audio. Certifications can be verified. Certifications can be verified as a precondition of rendering the ToS and/or content.

In many embodiments, ToS can include terms. Examples of terms can include payments of royalties; reporting of transactions and selected use type; reporting of and payment of sales taxes; reporting of transactions for the purpose of other tax collection, and/or to determine legality of content in a given jurisdiction of use; the execution of scripts to perform tasks (e.g., related to enforcement of digital rights management (DRM) mechanisms); and/or the verification of and/or reporting of platform compliance with terms (e.g., where terms associated with a token can require that use of the content, at least of some types, is performed at least in part using a trusted execution environment (TEE)).

In many embodiments, the initiation of actions (e.g., such as the transfer of ownership, rendering of content, and/or other actions described herein), can cause data to be read from metadata fields of tokens. In several embodiments the initiation of actions can cause determinations as to whether the read data includes information (e.g., instructions), that determine that a user-facing action should be performed. In a number of embodiments, user facing actions can include the rendering of notifications. When users take actions (e.g., such as clicking on “I agree to the terms” or having previously configured her system to automatically agree to the terms on the user's behalf), then the initiated action can be performed; otherwise an alternative action can be taken. In some embodiments, alternative actions can include the reporting of a problem to a third party; the notification to a user of a failure to perform an initiated action; the logging of the user action leading to an alternative action; the blocking of and initiated action; the halting of the initiation of an action; and/or versions and combinations of these alternative actions. In several embodiments, when user systems are configured to automatically agree to terms and/or users agree to the terms, this agreement can be logged or communicated to a third party. In some embodiments, the third party can perform record keeping of agreements to terms. In a number of embodiments, when it is determined that a user or entity (e.g. device) signaled an intent to agree to terms, but there is no corresponding action taken (e.g., no payment is made in spite of this being implied by the agreement to the terms), then a corrective action can be initiated. In many embodiments, these aforementioned determinations can be performed by a third party associated with the record keeper, and/or by a device and/or software unit accessing log information and payment information. In a number of embodiments corrective actions can include notification of law enforcement of potential abuse; and/or automated restriction of capabilities of one or more devices or software agents associated with the user corresponding to the detected abuse. In various embodiments, restrictions can be limited in time until a resolution is found. In several embodiments, a resolution can be found by the user paying a fine and/or providing evidence that the action causing the corrective action was taken in error.

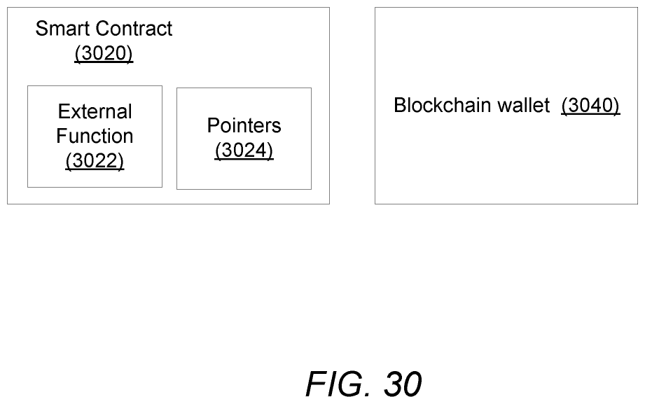

In several embodiments, the various aspects described throughout can be implemented using smart contracts and/or blockchain wallets. An example implementation using a smart contract and a suitable blockchain wallet is conceptually illustrated in FIG. 30. Aspects described elsewhere herein can be implemented using a smart contract 3020 and a blockchain wallet 3040. The smart contract 3020 can provide an external function 3022. External functions can be queried by wallets. External functions can include capabilities to implement various aspects described throughout. External functions can return terms and conditions (e.g., ToS) applying to transfers of NFTs. The transfers of NFTs can be instantiated by the smart contract (e.g. smart contract 3020) and/or by another entity. In several embodiments, smart contracts can return pointers (e.g. pointers 3024) to off-chain files stored in a public file server and/or on the InterPlanetary File Server (IPFS). Off-chain files can detail terms and conditions. In many embodiments, external functions can return initial verification data. In some embodiments, initial verification data can include recognition and acceptance of the terms and/or conditions which must be utilized in a subsequent NFT transfer transaction. In a number of embodiments, a smart contract can return initial validation data including a value obtained through an algorithm such as a hash function. In various embodiments a hash function taking as an input: a current block height of the blockchain, a value specific to the NFT in question such as its identifier, and/or the address querying the smart contract. In various embodiments, various different values and/or algorithms can be used to obtain one or more values returned as initial verification data. In several embodiments, subsequent to submitting a transfer transaction (e.g., to transfer the NFT), further transaction validation data can be required by a smart contract transfer function. In several embodiments, the smart contract can require a “from” address, a “to” address, an NFT identifier, and/or transaction validation data. Transaction validation data can include one or more of: the values provided as initial verification data earlier, that the transfer transaction is included in a block within a predetermined range from the previously returned current block height of the blockchain within the initial verification data, that the address requesting the transfer matches the address querying the smart contract previously provided, that an NFT identifier to be transferred matches the value specific to the NFT in question previously provided, and/or, that the transfer transaction provided includes data that, when hashed, returns a result matching said hash (e.g., in the case of the initial verification data including a hash).

While specific systems and components for an implementation using a smart contract and a suitable blockchain wallet are described above, any of a variety of systems and components can be utilized for a device for an implementation using a smart contract and a suitable blockchain wallet as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to an implementation using a smart contract and a suitable blockchain wallet the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

In various embodiments, smart contracts can further return (e.g., within the initial verification data) a list of values corresponding to a list of options presented in the terms and conditions. In some embodiments, the values can be integers corresponding to the options. In several embodiments, the following, or a modification of the following show integers corresponding to options. 1—transfer is an internal transfer, 2—transfer is to a relative or beneficiary of a will, 3—transaction is a private financial sale, 4—transfer is due to a public auction 5—transaction is tax exempt, and so on. In various embodiments, the values can correspond to hashes of each clause within the terms and conditions. In several embodiments, wallets can query smart contracts and present these options to the user in the user interface. In many embodiments, users can select which option(s) is(are) relevant to the present transaction. Based on the selection the wallet can construct a transfer transaction. The constructed transfer transaction can include one or more of: appropriate transaction validation data, an identifier of a selection from the list of options presented, appropriate payment for the selection, and/or other data required to construct and present a valid transaction to the smart contract.

In several embodiments, wallets can further pass data in the transaction. The data can indicate the software build and version of the wallet used to submit the transaction. This data can thereby provide on-chain evidence that the user utilized wallet software in which transaction details options were indeed made visible to the user.

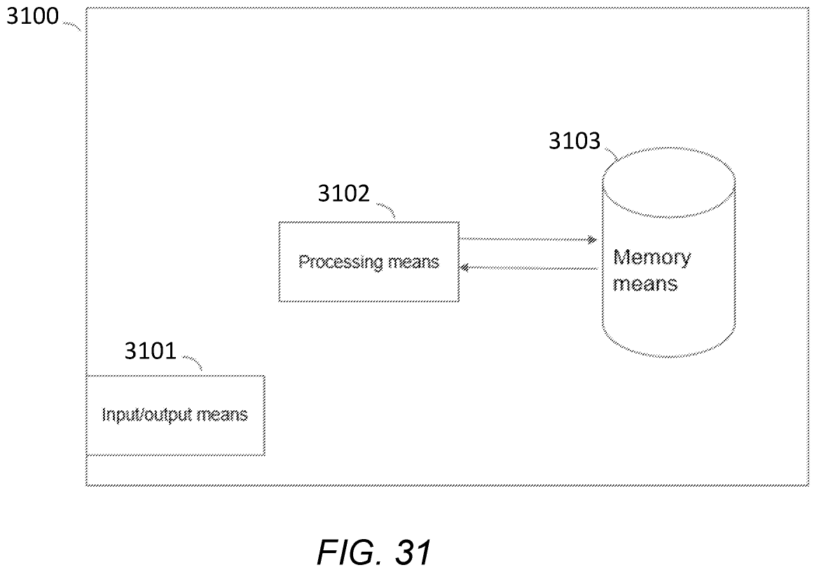

In several embodiments, a device can be used to enable enforcing rules associated with NFTs. An example of a device for enabling enforcing of rules associated with an NFT is conceptually illustrated in FIG. 31. The device 3100 can include an input/output means 3101, by means of which the device may receive information and transmit or provide information to other units, devices and/or entities. The device 3100 can include a processing means 3102 and a memory means 3103. Memory means can include instructions, which when executed by processing means can cause devices to perform the process described herein.

While specific systems and components for a device for enabling enforcing of rules associated with an NFT are described above, any of a variety of systems and components can be utilized for a device for enabling enforcing of rules associated with an NFT as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a device for enabling enforcing of rules associated with an NFT the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

While specific systems, components, and/or processes are described with respect to NFTs or to tokens, it is understood that where specific systems, components, and/or processes apply to NFTs, they could also apply to tokens, and vice versa.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A device configured to implement a distributed ledger capable of immutably recording a first set of data and a second set of data of an item, wherein the second set of data is made available by satisfaction of a condition, the device comprising:
a network interface; and
memory;
a processor, the processor configured to:
obtain a conditional item, the conditional item comprising:
a first set of data that is available, the first set of data comprising:
first content; and
a first policy;
a second set of data that is unavailable, the second set of data comprising:
second content; and
a second policy;
determine whether a condition is satisfied, and when the condition is satisfied perform an evolution to the conditional item, wherein the evolution makes the second set of data become available;
generate a transaction record, the transaction record comprising the conditional item; and
broadcast the transaction record, the transaction record configured to be incorporated into a ledger entry, wherein the ledger entry is capable of being used to compute a challenge for securely adding the ledger entry to a distributed ledger using a cryptographic system.

2. The device of claim 1, wherein the conditional item is a token.

3. The device of claim 1, wherein the conditional item is a non-fungible token.

4. The device of claim 1, wherein the evolution alters access rights of the conditional item, wherein the access rights are associated with public keys.

5. The device of claim 1, wherein the evolution alters ownership of the item.

6. The device of claim 1, wherein the evolution alters the second content associated with the item.

7. The device of claim 1, wherein the evolution alters an image associated with the item.

8. The device of claim 1, wherein the condition requires that a threshold number of blocks have been added to the distributed ledger since a transaction transferring ownership of the item has been recorded.

9. The device of claim 1, wherein the condition requires that a transaction recipient have specific characteristics.

10. The device of claim 1, wherein the second set of data further comprises personalizations, wherein the personalizations are determined based on qualifying transactions.

11. The device of claim 1, wherein the second set of data can include personalizations, wherein the personalizations are determined based on qualifying transactions and personalizations effect a function of the conditional item.

12. The device of claim 1, wherein inspection of the first policy is available publicly using the distributed ledger.

13. The device of claim 1, wherein inspection of the first policy is available to particular entities based on public-key private-key encryption.

14. The device of claim 1, wherein the condition can be satisfied based on an occurrence of an event.

15. The device of claim 1, wherein the condition can be satisfied based on an occurrence of an external event.

16. The device of claim 1, wherein the condition can be satisfied based on an occurrence of an internal event.

17. The device of claim 1, wherein the conditional item is associated with a related set of items, and the condition requires that the conditional item and at least one item from the related set of items are associated by ownership to a public key.

18. A device configured to implement a distributed ledger capable of immutably recording an action, the action selected based on an evaluation of an item policy, the device comprising:
a network interface;
memory; and
a processor, the processor configured to:
obtain a conditional item, the conditional item comprising:
a set of data, the set of data comprising:
content;
a policy, wherein the policy includes executable code;
execute the executable code to:
identify a request made to the conditional item;
determine whether a condition has been satisfied;
select an action descriptor when the condition has been satisfied;
generate a transaction record, wherein the transaction record is generated based on the action descriptor; and
broadcast the transaction record, the transaction record configured to be incorporated into a ledger entry, wherein the ledger entry is capable of being used to compute a challenge for securely adding the ledger entry to a distributed ledger using a cryptographic system.

19. The device of claim 18, wherein the transaction record comprises address information for a content originator, wherein the content originator created the conditional item.

20. A device configured to implement a distributed ledger capable of immutably recording a first set of data and a second set of data of an item, wherein the second set of data is made available by satisfaction of a condition, the device comprising:
a network interface;
memory; and
a processor, the processor configured to:
obtain a conditional item at a transfer time, the conditional item comprising:
a first set of data that is available, the first set of data comprising:
first content;
a first policy, the first policy comprising:
first access rights, the first access rights associated with a content file and a public key; and
a condition, wherein the condition is satisfied after a preset amount of time elapses since the transfer time;
a second set of data that is unavailable, the second set of data comprising:
second content; and
a second policy comprising second access rights, the second access rights associated with the content file and the public key;
determine whether a condition is satisfied, and when the condition is satisfied perform an evolution to the conditional item, wherein the evolution makes the second set of data become available.
